(19) United States
(12) Patent Application Publication
(10) Pub. No.: US 2007/0135283 A1
(43) Pub. Date: Jun. 14, 2007

(54) Insert for Protecting a Product within a Box

(76) Inventor: David F. Kari, Carol Stream, IL (US)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 11/567,980

(22) Filed: Dec. 7, 2006

Related U.S. Application Data
(60) Provisional application No. 60/749,547, filed on Dec. 12, 2005.

(51) Int. Cl. B31B 1/00

(52) U.S. Cl. 493/51

(57) ABSTRACT

A corrugated fibreboard blank is configured to be folded into an insert. The insert is configured to receive and protect a product therein and the insert is configured to be received within a shipping container. The shape of the insert produces void spaces that the products cannot reach, thus creating natural air cells within the insert. The ends, tabs and panels of the insert also provide for minimal movement of the product within the insert and further provide layers of cushioning upon impact. The ends of the insert can also be folded in varying manners in order to vary an interior dimension of the insert. The insert can secure a variety of different sized products, is environmentally friendly, inexpensive and space-saving. The insert can be secured in its shape with either tabs, adhesives, or a combination of both.

### CROSS-REFERENCE AND INCORPORATION BY REFERENCE

This application claims the domestic priority of U.S. Provisional Application Ser. No. 60/749,547, filed on Dec. 12, 2005, and entitled “Insert For Protecting A Product Within A Box”. U.S. Provisional Application Ser. No. 60/749,547 is hereby incorporated by reference in its entirety.

### BACKGROUND OF THE INVENTION

This invention relates to corrugated fibreboard inserts which fit into a carton to receive and protect an elongated or generally rectangular product and more particularly—but not exclusively—to inserts which can accommodate toner or similar cartridges having any of a number of different configurations.

In general, the invention is directed to packaging elongated or generally rectangular products, such as a VCR cartridge, a glass ornament, a work of art, a portable radio, or the like. For convenience of description, all of these and other objects will hereinafter be included in the term “toner cartridge” for a computer printer.

Some fields of a product have parts which are very similar and yet are also different in detail. This means that the manufacturer of that product has often been required to inventory a different packaging system for each product in the field. This need not only increases costs for warehousing, handling, and the like, but also creates inefficiencies because the correct box may not always be available or may be in the wrong place at the wrong time.

A toner cartridge is an example of such a product. There are many manufacturers of printers which use toners in cartridges of its own design. Each manufacturer may also have a variety of toner cartridges which have evolved with improvements over the years. The same toner manufacturer may supply toner for most, if not all of these cartridges, for printers of different manufacturers. Therefore, that toner manufacturer will want to minimize the types and styles of packaging material which it must keep in inventory, despite the fact that each printer manufacturer has its own design. The problem is further complicated since a toner cartridge does not have the smooth configuration of a rectangular box, such as a VCR cartridge.

Another consideration is the type of packaging material insofar as its bulk, ease of use, disposition and the like. For example, one type of packaging material is either molded pulp or polystyrene foam that is molded in a shape which receives and cradles a toner cartridge. Also, this requires mold tooling. It is particularly inefficient since the molded shape may not receive essentially the same cartridge if this surface contour is changed without altering the overall outer dimensions. This type of molded packaging is bulky and is costly to store and transport since it amounts to storing and shipping air. Further, it creates bulky trash for the customer to discard. In the case of polystyrene, the material is not recyclable or environmentally friendly.

A desirable form of packaging is a corrugated fibreboard insert because it is inexpensive, and can be stored flat to take up a minimum amount of room. It is recyclable and environmentally friendly. Such an insert should be simple, easy to fold, and to interlock into place with a minimum amount of effort. Also, it should be easy for the customer to unfold and re-use. Further, it should be versatile and equally easy to form and use any blank for any of many types of cartridge that may be fitted therein.

When the corrugated fibreboard blank is designed, it should use as small an amount of fibreboard as possible considering the need to physically protect the product. It should have reliable interlocking parts or other means to keep it in an assembled condition.

### SUMMARY OF THE INVENTION

Briefly, and in accordance with the foregoing, the invention provides a corrugated fibreboard blank which may be folded into an insert. The insert is configured to receive and protect a product therein and the insert is configured to be received within a shipping container. The shape of the insert produces void spaces that the products cannot reach, thus creating natural air cells within the insert. The ends, tabs and panels of the insert also provide for minimal movement of the product within the insert and further provide layers of cushioning upon impact. The ends of the insert can also be folded in varying manners in order to vary an interior dimension of the insert. The insert can secure a variety of different sized products, is environmentally friendly, inexpensive and space-saving. The insert can be secured in its shape with either tabs, adhesives, or a combination of both.

### BRIEF DESCRIPTION OF THE DRAWINGS

The features of the invention which are believed to be novel are described in detail hereinbelow. The organization and manner of the structure and operation of the invention, together with further objects and advantages thereof, may best be understood by reference to the following description taken in connection with the accompanying drawings wherein like reference numerals identify like elements in which:

FIG. 1 is a top plan view of a blank used to form an insert of the invention;

FIG. 2 is a bottom plan view of the blank used to form the insert of the invention;

FIGS. 3-17 illustrate a first method of folding the blank to form the insert of the invention which secures a product therein;

FIG. 18 is a perspective view of a shipping container into which the insert is positioned within;

FIG. 19 is a perspective view of the insert of the invention positioned within the shipping container;

FIG. 20 illustrates a second method of folding the blank to form the insert of the invention which secures a product therein;

FIG. 21 illustrates a third method of folding the blank to form the insert of the invention which secures a product therein;

FIG. 22 illustrates a first manner of closing off the ends of the opening of the insert to provide a first interior dimension of the insert;

FIG. 23 illustrates a second manner of closing off the ends of the opening of the insert to provide a second interior dimension of the insert;

FIG. 24 illustrates a third manner of closing off the ends of the opening of the insert to provide a third interior dimension of the insert;

FIG. 25 illustrates a fourth manner of closing off the ends of the opening of the insert to provide a fourth interior dimension of the insert; and

FIG. 26 illustrates a fifth manner of closing off the ends of the opening of the insert to provide a fifth interior dimension of the insert.

### DETAILED DESCRIPTION OF THE ILLUSTRATED EMBODIMENT

While this invention may be susceptible to embodiment in different forms, there is shown in the drawings and will be described herein in detail, a specific embodiment with the understanding that the present disclosure is to be considered an exemplification of the principles of the invention, and is not intended to limit the invention to that as illustrated.

Attention is directed to the blanks 900 used in forming the novel insert 902.

It should be noted that while the blank 900 has been described hereinbelow as having certain dimensions, that these dimensions should be understood to be only one preferred embodiment of the blank 900 and are provided merely for reference purposes; the dimensions may be changed or adjusted as desired while keeping with the spirit of the invention such that the insert 902 formed from the blank 900 can receive and secure different size products 904 and such that the insert 902 can be positioned within different size cartons or boxes 906. It should further be noted that the drawings illustrating the blank 900 and the insert 902 are not necessarily drawn to scale.

It should further be noted that parts of the blank 900 are referenced as being parallel to, perpendicular to, co-planar with and/or bisected by other parts of the blank 900. These are the preferred manner in which these parts are configured relative to one another, but it is to be understood that they need not be exactly parallel, perpendicular, co-planar or bisected, just that they are generally parallel, perpendicular, co-planar or bisected.

In the drawings, fold lines are denoted by dashed lines while cut lines within the confines of the blank 900 are denoted by solid lines. It is also to be understood that the drawings do not generally illustrate the thickness of the blank 900 for clarity purposes. In the preferred embodiment, the blank 900 has a thickness of one-eighth (0.125) inches, but may also have other thicknesses, such as three-sixteenths (0.1875) inches, for example.

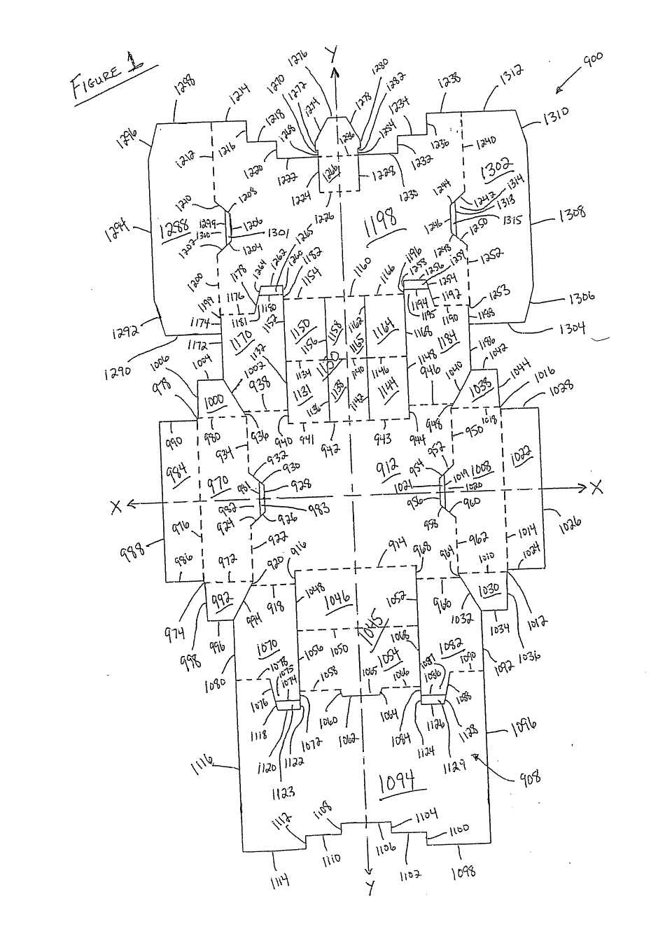

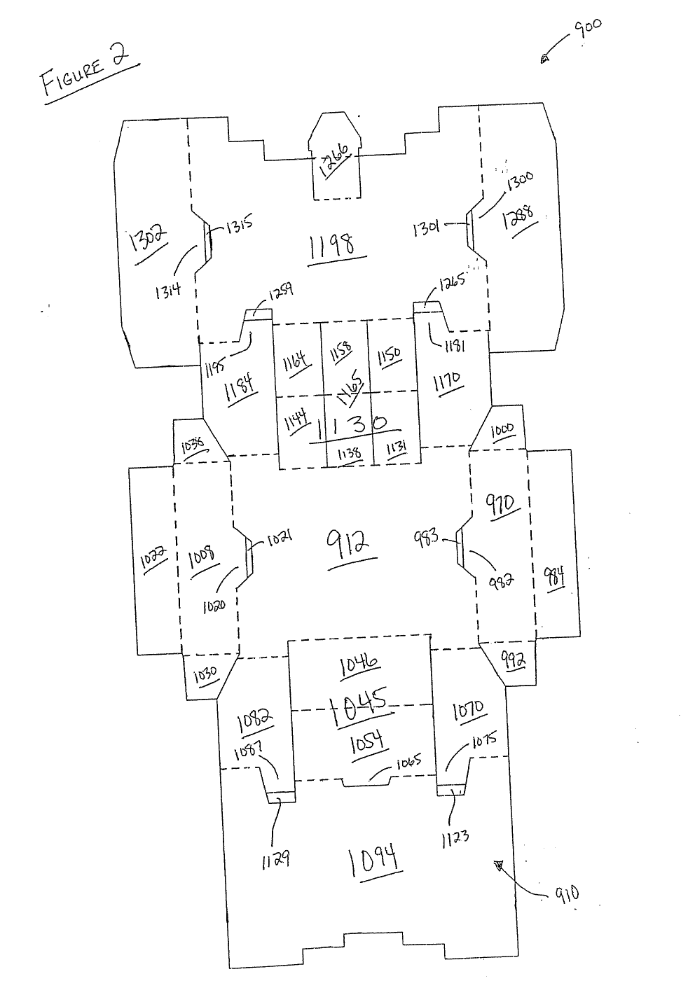

Attention is directed to FIGS. 1 and 2 which illustrate a blank 900 which may be folded to form an insert 902 for receiving, protecting and securing a product 904, such as a toner cartridge. The insert 902 with the product 904 secured therein, can then be inserted into a carton or box 906 for shipping and storage. The blank 900 is preferably formed of corrugated fibreboard. The blank 900 has a top surface 908, which is illustrated in FIG. 1, and a bottom surface 910, which is illustrated in FIG. 2.

A horizontal centerline X-X is provided in FIG. 1. It is to be understood that hereinafter in the description of the blank 900, which is provided below the horizontal centerline X-X as viewed in FIG. 1, that the terms “upward” and/or “upwardly” or similar will be used to describe elements, such as fold lines, cut lines and edges, which extend toward the horizontal centerline X-X, and that the terms “downward” and/or “downwardly” or similar will be used to describe elements, such as fold lines, cut lines and edges, which extend away from the horizontal centerline X-X. It is further to be understood that hereinafter in the description of the blank 900, which is provided above the horizontal centerline X-X as viewed in FIG. 1, that the terms “upward” and/or “upwardly” or similar will be used to describe elements, such as fold lines, cut lines and edges, which extend away from the horizontal centerline X-X, and that the terms “downward” and/or “downwardly” or similar will be used to describe elements, such as fold lines, cut lines and edges, which extend toward the horizontal centerline X-X.

A vertical centerline Y-Y is provided in FIG. 1. It is to be understood that hereinafter in the description of the blank 900 that the terms “outward” and/or “outwardly” or similar will be used to describe elements, such as fold lines, cut lines and edges, which extend away from the vertical centerline Y-Y. It is further to be understood that hereinafter in the description of the blank 900 that the terms “inward” and/or “inwardly” or similar will be used to describe elements, such as fold lines, cut lines and edges, which extend toward the vertical centerline Y-Y.

The blank 900 has a base panel 912 which is defined by fold line 914, cut line 916, fold line 918, cut line 920, fold line 922, cut lines 924, 926, 928, 930, 932, fold line 934, cut line 936, fold line 938, cut line 940, fold lines 941, 942, 943, cut line 944, fold line 946, cut line 948, fold line 950, cut lines 952, 954, 956, 958, 960, fold line 962, cut line 964, fold line 966 and cut line 968.

Fold line 914 extends a distance of six (6) inches and, as illustrated in FIG. 1, is provided parallel to, and at a distance of two and one-sixteenth (2.0625) inches below, the horizontal centerline X-X, and is bisected by the vertical centerline Y-Y.

Cut line 916 is perpendicular to fold line 914 and extends downwardly from one end of the fold line 914 for a distance of three-eighths (0.375) inches to fold line 918.

Fold line 918 is perpendicular to cut line 916 and parallel to fold line 914. Fold line 918 extends outwardly from cut line 916 to cut line 920.

Cut line 920 extends angularly upwardly and inwardly from fold line 918 to fold line 922.

Fold line 922 is perpendicular to fold line 918 and parallel to cut line 916. Fold line 922 extends upwardly from cut line 920 to cut line 924. Fold line 922 is separated from cut line 916 by a distance of two and one-eighth (2.125) inches.

Cut line 924 extends angularly upwardly and inwardly from fold line 922 to cut line 926.

Cut line 926 extends angularly upwardly and inwardly from cut line 924 to cut line 928. Cut line 926 is co-planar with cut line 924 such that cut lines 924, 926 generally form a single cut line, but cut lines 924, 926 are described separately for convenience in describing the blank 900.

Cut line 928 extends parallel to fold lines 916, 922. Cut line 928 extends upwardly from cut line 926 to cut line 930. As illustrated in FIG. 1, cut line 928 is bisected by the horizontal centerline X-X.

Cut line 930 extends angularly upwardly and outwardly from cut line 928 to cut line 932.

Cut line 932 extends angularly upwardly and outwardly from cut line 930 to fold line 934. Cut line 932 is co-planar with cut line 930 such that cut lines 930, 932 generally form a single cut line, but cut lines 930, 932 are described separately for convenience in describing the blank 900.

Fold line 934 extends parallel to cut line 928 and is co-planar with fold line 922. Fold line 934 extends upwardly from cut line 932 to cut line 936. Fold line 934 is separated from fold line 922 by a distance of one and one-half (1.5) inches.

Cut line 936 extends angularly upwardly and outwardly from fold line 934 to fold line 938.

Fold line 938 is perpendicular to fold line 934 and parallel to fold line 918. Fold line 938 extends inwardly from cut line 936 to cut line 940. Fold line 938 is separated from fold line 918 by a distance of four and seven-eighths (4.875) inches.

Cut line 940 is perpendicular to fold line 938 and co-planar with cut line 916. Cut line 940 extends downwardly from fold line 938 for a distance of three-eighths (0.375) inches to fold line 941. Cut line 940 is separated from cut line 916 by a distance of four and one-eighth (4.125) inches. Cut line 940 is separated from fold line 934 by a distance of two and one-eighth (2.125) inches.

Fold line 941 is perpendicular to cut line 940 and is parallel to fold lines 914, 938. Fold line 941 extends inwardly from cut line 940 for a distance of two (2) inches to fold line 942. Fold line 941 is separated from fold line 914 by a distance of four and one-eighth (4.125) inches.

Fold line 942 is co-planar with fold line 941. Fold line 942 extends inwardly from fold line 941 for a distance of one (1) inch to the vertical centerline Y-Y, and then outwardly from the vertical centerline Y-Y for a distance of one (1) inch to fold line 943, such that the vertical centerline Y-Y bisects the fold line 942. Fold line 942 is separated from fold line 914 by a distance of four and one-eighth (4.125) inches.

Fold line 943 is co-planar with fold line 942. Fold line 943 extends outwardly from fold line 942 for a distance of two (2) inches to cut line 944. Fold line 943 is separated from fold line 914 by a distance of four and one-eighth (4.125) inches. Fold lines 941, 942, 943 are all co-planar such that fold lines 941, 942, 943 generally form a single fold line, but fold lines 941, 942, 943 are described separately for convenience in describing the blank 900.

Cut line 944 is perpendicular to fold line 943 and parallel with cut line 940. Cut line 944 extends upwardly from fold line 943 for a distance of three-eighths (0.375) inches to fold line 946. Cut line 944 is separated from cut line 940 by a distance of six (6) inches.

Fold line 946 is perpendicular to cut line 944, parallel to fold lines 941, 942, 943, and co-planar with fold line 938. Fold line 946 extends outwardly from cut line 944 to cut line 948. Fold line 946 is separated from fold line 938 by a distance of six (6) inches.

Cut line 948 extends angularly downwardly and inwardly from fold line 946 to fold line 950. Cut line 948 is parallel to cut line 920.

Fold line 950 is perpendicular to fold line 946 and is parallel to fold line 934. Fold line 950 extends downwardly from cut line 948 to cut line 952. Fold line 950 is separated from fold line 934 by a distance often and one-quarter (10.25) inches. Fold line 950 is separated from cut line 944 by a distance of two and one-eighth (2.125) inches.

Cut line 952 extends angularly downwardly and inwardly from fold line 950 to cut line 954.

Cut line 954 extends angularly downwardly and inwardly from cut line 952 to cut line 956. Cut line 954 is co-planar with cut line 952 such that cut lines 952, 954 generally form a single cut line, but cut lines 952, 954 are described separately for convenience in describing the blank 900. Cut lines 952, 954 are parallel to cut lines 924, 926.

Cut line 956 extends parallel to fold line 950 and cut line 928. Cut line 956 extends downwardly from cut line 954 to cut line 958. As illustrated in FIG. 1, cut line 956 is bisected by the horizontal centerline X-X.

Cut line 958 extends angularly downwardly and outwardly from cut line 956 to cut line 960.

Cut line 960 extends angularly downwardly and outwardly from cut line 958 to fold line 962. Cut line 960 is co-planar with cut line 958 such that cut lines 958, 960 generally form a single cut line, but cut lines 958, 960 are described separately for convenience in describing the blank 900. Cut lines 958, 960 are parallel to cut lines 930, 932.

Fold line 962 is parallel to cut line 956, parallel to fold line 922, and co-planar with fold line 950. Fold line 962 extends downwardly from cut line 960 to cut line 964. Fold line 962 is separated from fold line 950 by a distance of one and one-half (1.5) inches. Fold line 962 is separated from fold line 922 by a distance of ten and one-quarter (10.25) inches.

Cut line 964 extends angularly downwardly and outwardly from fold line 962 to fold line 966. Cut line 964 is parallel to cut line 936.

Fold line 966 is perpendicular to fold line 962, parallel to fold line 914, and co-planar to fold line 918. Fold line 966 extends inwardly from cut line 964 to cut line 968. Fold line 966 is separated from fold line 946 by a distance of four and seven-eighths (4.875) inches. Fold line 966 is separated from fold line 918 by a distance of six (6) inches.

Cut line 968 is perpendicular to fold lines 914, 966, parallel to cut line 916 and fold line 962, and co-planar to cut line 944. Cut line 968 extends upwardly from cut line 960 for a distance of three-eighths (0.375) inches to fold line 914. Cut line 968 is separated from fold line 962 by a distance of two and one-eighth (2.125) inches. Cut line 968 is separated from cut line 916 by a distance of six (6) inches. Cut line 968 is separated from cut line 944 by a distance of four and one-eighth (4.125) inches.

The blank 900 has a first intermediate panel 970 which is defined by fold line 972, edge 974, fold line 976, edge 978, fold line 980, fold line 934, cut lines 932, 981, 924, and fold line 922.

Fold line 972 extends outwardly from the connection of cut line 920 and fold line 922 for a distance of two and seven-sixteenths (2.4375) inches to edge 974. Fold line 972 is parallel to fold line 918 and perpendicular to fold line 922. Fold line 972 is separated from fold line 918 by a distance of one-eighth (0.125) inches.

Edge 974 extends angularly upwardly and outwardly from fold line 972 to fold line 976.

Fold line 976 is perpendicular to fold line 972 and parallel to fold lines 922, 934 and cut line 928. Fold line 976 extends upwardly from edge 974 for a distance of four and one-half (4.5) inches to edge 978. Fold line 976 is separated from fold lines 922, 934 by a distance of two and one-half (2.5) inches.

Edge 978 extends angularly upwardly and inwardly from fold line 976 to fold line 980.

Fold line 980 is perpendicular to fold lines 934, 976, and parallel to fold lines 918, 938. Fold line 980 extends inwardly from edge 978 to the intersection of fold line 934 and cut line 936. Fold line 980 is separated from fold line 938 by a distance of one-eighth (0.125) inches. Fold line 980 is separated from fold line 972 by a distance of four and five-eighths (4.625) inches.

Cut line 981 is parallel to cut line 928 and fold line 976. Cut line 981 extends downwardly from the intersection of cut lines 930, 932 to the intersection of cut lines 924, 926. Cut line 981 is separated from fold line 976 by a distance of three (3) inches.

The first intermediate panel 970 has a first tab portion 982 which is generally defined by the cut lines 924, 981, 932.

The blank 900 has a first aperture 983 provided therethrough which is defined by the cut lines 926, 928, 930, 981 such that the first aperture 983 is generally trapezoidal in configuration.

The blank 900 has a first side panel 984 which is generally rectangular in configuration. The first side panel 984 is generally defined by the fold line 976 and edges 986, 988, 990.

Edge 986 extends outwardly from the intersection of edge 974 and fold line 976 for a distance of one and seven-eighth (1.875) inches to edge 988. Edge 986 is parallel to fold line 972 and is perpendicular to fold line 976.

Edge 988 is perpendicular to edge 986 and parallel to fold line 976. Edge 988 extends upwardly from edge 986 for a distance of four and one-half (4.5) inches to edge 990. Edge 988 is separated from fold line 976 by a distance of one and seven-eighth (1.875) inches.

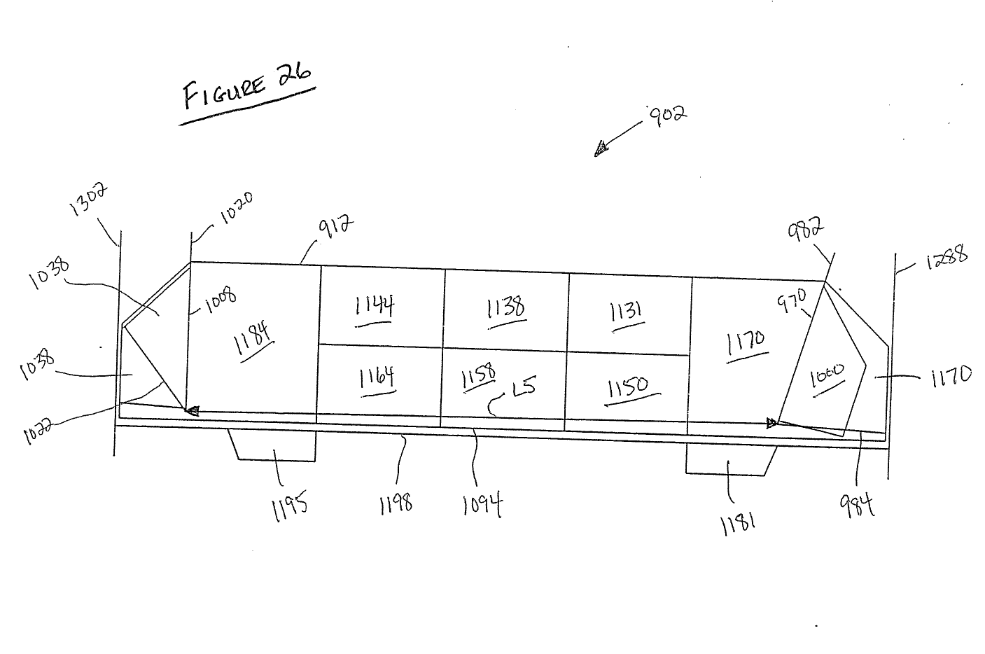

Edge 988 is bisected by horizontal centerline X-X as illustrated in FIG. 1, and also defines a leftmost edge of blank 900 as viewed in FIG. 25.

Edge 990 is perpendicular to fold line 976 and edge 988, and parallel to edge 986 and fold line 980. Edge 990 extends inwardly from edge 988 for a distance of one and seven-eighth (1.875) inches to the intersection of fold line 976 and edge 978. Edge 990 is separated from edge 986 by a distance of four and one-half (4.5) inches.

The blank 900 has a first wing panel 992 which is generally trapezoidal in configuration. The first wing panel 992 is defined by fold line 972, cut lines 920, 994, and edges 996, 998.

Cut line 994 extends angularly downwardly and outwardly from cut line 920 to edge 996. Cut line 994 is co-planar with cut line 920 such that cut lines 920, 994 generally form a single cut line, but cut lines 920, 994 are described separately for convenience in describing the blank 900.

Edge 996 is parallel to fold line 972. Edge 996 extends outwardly from cut line 994 for a distance of one and five-sixteenths (1.3125) inches to edge 998. Edge 996 is separated from fold line 972 by a distance of one and one-sixteenth (1.0625) inches.

Edge 998 extends angularly upwardly and outwardly from edge 996 to the intersection of fold line 972 and edge 974.

The blank 900 has a second wing panel 1000 which is generally trapezoidal in configuration. The second wing panel 1000 is defined by fold line 980, cut lines 936, 1002, and edges 1004, 1006.

Cut line 1002 extends angularly upwardly and outwardly from cut line 936 to edge 1004. Cut line 1002 is co-planar with cut line 936 such that cut lines 936, 1002 generally form a single cut line, but cut lines 936, 1002 are described separately for convenience in describing the blank 900.

Edge 1004 is parallel to fold line 980. Edge 1004 extends outwardly from cut line 1002 for a distance of one and five-sixteenths (1.3125) inches to edge 1006. Edge 1006 is separated from fold line 980 by a distance of one and one-sixteenth (1.0625) inches.

Edge 1006 extends angularly downwardly and outwardly from edge 1004 to the intersection of fold line 980 and edge 978.

The blank 900 has a second intermediate panel 1008 which is defined by fold line 1010, edge 1012, fold line 1014, edge 1016, fold line 1018, fold line 950, cut lines 952, 1019, 960, and fold line 962.

Fold line 1010 extends outwardly from the connection of cut line 964 and fold line 962 for a distance of two and seven-sixteenths (2.4375) inches to edge 1012. Fold line 1010 is parallel to fold line 966, perpendicular to fold line 962, and co-planar to fold line 972. Fold line 1010 is separated from fold line 966 by a distance of one-eighth (0.125) inches. Fold line 1010 is separated from fold line 972 by a distance of ten and one-half (110.5) inches.

Edge 1012 extends angularly upwardly and outwardly from fold line 1010 to fold line 1014. Edge 1012 is parallel to edge 978.

Fold line 1014 is perpendicular to fold line 1010 and parallel to fold lines 950, 962 and cut line 956. Fold line 1014 extends upwardly from edge 1012 for a distance of four and one-half (4.5) inches to edge 1016. Fold line 1014 is separated from fold lines 950, 962 by a distance of two and one-half (2.5) inches Edge 1016 extends angularly upwardly and inwardly from fold line 1014 to fold line 1018.

Fold line 1018 is perpendicular to fold lines 950, 1014, parallel to fold lines 946, 966, and co-planar with fold line 980. Fold line 1018 extends inwardly from edge 1016 to the intersection of cut line 948 and fold line 950. Fold line 1018 is separated from fold line 946 by a distance of one-eighth (0.125) inches. Fold line 1018 is separated from fold line 1010 by a distance of four and five-eighths (4.625) inches. Fold line 1018 is separated from fold line 980 by a distance of ten and one-quarter (10.25) inches.

Cut line 1019 is parallel to cut line 956 and fold line 1014. Cut line 1019 extends downwardly from the intersection of cut lines 952, 954 to the intersection of cut lines 958, 960. Cut line 1019 is separated from fold line 1014 by a distance of three (3) inches.

The second intermediate panel 1008 has a second tab portion 1020 which is generally defined by the cut lines 952, 1019, 960.

The blank 900 has a second aperture 1021 provided therethrough which is defined by the cut lines 954, 956, 958, 1019 such that the second aperture 1021 is generally trapezoidal in configuration.

The blank 900 has a second side panel 1022 which is generally rectangular in configuration. The second side panel 1022 is generally defined by the fold line 1014 and edges 1024, 1026, 1028.

Edge 1024 extends outwardly from the intersection of edge 1012 and fold line 1014 for a distance of one and seven-eighth (1.875) inches to edge 1024. Edge 1024 is parallel to fold line 1010, perpendicular to fold line 1014, and co-planar with edge 986. Edge 1024 is separated from edge 986 by a distance of fifteen and one-quarter (15.25) inches.

Edge 1026 is perpendicular to edge 1024 and parallel to fold line 1014 and edge 988. Edge 1026 extends upwardly from edge 1024 for a distance of four and one-half (4.5) inches to edge 1028. Edge 1028 is separated from fold line 1014 by a distance of one and seven-eighth (1.875) inches. Edge 1028 is separated from edge 988 by a distance of nineteen (19) inches. Edge 1026 is bisected by horizontal centerline X-X as illustrated in FIG. 1, and also defines a rightmost edge of the blank 900 as viewed in FIG. 1.

Edge 1028 is perpendicular to fold line 1014 and edge 1026, parallel to edge 1024 and fold line 1018, and co-planar with edge 990. Edge 1028 extends inwardly from edge 1026 for a distance of one and seven-eighth (1.875) inches to the intersection of fold line 1014 and edge 1016. Edge 1028 is separated from edge 1024 by a distance of four and one-half (4.5) inches. Edge 1028 is separated from edge 990 by a distance of fifteen and one-quarter (15.25) inches.

The blank 900 has a third wing panel 1030 which is generally trapezoidal in configuration. The third wing panel 1030 is defined by fold line 1010, cut lines 964, 1032, and edges 1034, 1036.

Cut line 1032 extends angularly downwardly and outwardly from cut line 964 to edge 1034. Cut line 1032 is co-planar with cut line 964 such that cut lines 964, 1032 generally form a single cut line, but cut lines 964, 1032 are described separately for convenience in describing the blank 900. Cut line 1032 is parallel with cut lines 936, 1002.

Edge 1034 is parallel to fold line 1010 and co-planar with edge 996. Edge 1034 extends outwardly from cut line 1032 for a distance of one and five-sixteenths (1.3125) inches to edge 1036. Edge 1034 is separated from fold line 1010 by a distance of one and one-sixteenth (1.0625) inches. Edge 1034 is separated from edge 996 by a distance often and one-quarter (10.25) inches.

Edge 1036 extends angularly upwardly and outwardly from edge 1034 to the intersection of fold line 1010 and edge 1012. Edge 1036 is parallel to edge 1006.

The blank 900 has a fourth wing panel 1038 which is generally trapezoidal in configuration. The fourth wing panel 1038 is defined by fold line 1018, cut lines 948, 1040, and edges 1042, 1044.

Cut line 1040 extends angularly upwardly and outwardly from cut line 948 to edge 1042. Cut line 1040 is co-planar with cut line 948 such that cut lines 948, 1040 generally form a single cut line, but cut lines 948, 1040 are described separately for convenience in describing the blank 900. Cut line 1040 is parallel with cut lines 920, 994.

Edge 1042 is parallel to fold line 1018 and co-planar with edge 1004. Edge 1042 extends outwardly from cut line 1040 for a distance of one and five-sixteenths (1.3125) inches to edge 1044. Edge 1042 is separated from fold line 1018 by a distance of one and one-sixteenth (1.0625) inches. Edge 1042 is separated from edge 1004 by a distance often and one-quarter (10.25) inches.

Edge 1044 extends angularly downwardly and outwardly from edge 1042 to the intersection of fold line 1018 and edge 1016.

The blank 900 has a First bridge panel 1045 which has a first panel portion 1046 and a second panel portion 1054. The first panel portion 1046 is defined by fold line 914, cut lines 916, 1048, fold line 1050, and cut lines 1052, 968. The second panel portion 1054 is defined by fold line 1050, cut line 1056, fold line 1058, cut lines 1060, 1062, 1064, fold line 1066 and cut line 1068.

Cut line 1048 extends downwardly from cut line 916 to fold line 1050. Cut line 1048 is co-planar with cut line 916 such that cut lines 916, 1048 generally form a single cut line, but cut lines 916, 1048 are described separately for convenience in describing the blank 900. Cut line 1048 is also co-planar with cut line 940.

Fold line 1050 is perpendicular to cut line 1048 and parallel to fold line 914. Fold line 1050 extends inwardly from cut line 1048 for a distance of three (3) inches to the vertical centerline Y-Y and from the vertical centerline Y-Y for a distance of three (3) inches to cut line 1052.

Cut line 1052 extends upwardly from fold line 1050 to cut line 968. Cut line 1052 is perpendicular to fold line 1050, parallel to cut line 1048, and co-planar with cut line 968. Cut lines 968, 1052 generally form a single cut line, but cut lines 968, 1052 are described separately for convenience in describing the blank 900. Cut line 1052 is also co-planar with cut line 944. Cut line 1052 is separated from cut line 1048 by a distance of six (6) inches.

Cut line 1056 extends downwardly from the intersection of cut line 1048 and fold line 1050 to fold line 1058. Cut line 1056 is co-planar with cut lines 916, 1048 such that cut lines 916, 1048, 1056 generally form a single cut line, but cut lines 916, 1048, 1056 are described separately for convenience in describing the blank 900. Cut line 1056 is also co-planar with cut line 940.

Fold line 1058 is perpendicular to cut line 1056 and parallel to fold line 1050. Fold line 1058 extends inwardly from cut line 1056 to cut line 1060.

Cut line 1060 extends angularly downwardly and inwardly from fold line 1058 to cut line 1062.

Cut line 1062 extends inwardly from cut line 1060 to the vertical centerline Y-Y and then outwardly to cut line 1064. Cut line 1062 is parallel to fold line 1058 and is provided three-sixteenths (0.1875) inches below where fold line 1058 is provided when viewed as in FIG. 1. Cut line 1062 is bisected by the vertical centerline Y-Y as illustrated in FIG. 1.

Cut line 1064 extends angularly upwardly and outwardly from cut line 1062 to fold line 1066.

Fold line 1066 is parallel to cut line 1062 and co-planar with fold line 1058. Fold line 1066 extends outwardly from cut line 1064 to cut line 1068.

Cut line 1068 extends upwardly from fold line 1066 to the intersection of fold line 1050 and cut line 1052. Cut line 1068 is perpendicular to fold lines 1050, 1058, 1066, parallel to cut line 1056, and co-planar with cut lines 968, 1052. Cut lines 968, 1052, 1068 generally form a single cut line, but cut lines 968, 1052, 1068 are described separately for convenience in describing the blank 900. Cut line 1068 is also co-planar with cut line 944. Cut line 1068 is separated from cut line 1056 by a distance of six (6) inches.

The second panel portion 1054 of the First bridge panel 1045 has a tab portion 1065 which is generally defined by the cut lines 1060, 1062, 1064.

The blank 900 has a third intermediate panel 1070 which is defined by fold line 918, cut lines 1048, 1056, 1072, 1074, 1076, fold line 1078, edge 1080, and cut line 994.

Cut line 1072 extends downwardly from the intersection of cut line 1056 and fold line 1058 to cut line 1074. Cut line 1072 is co-planar with cut lines 916, 1048, 1056 such that cut lines 916, 1048, 1056, 1072 generally form a single cut line, but cut lines 916, 1048, 1056, 1072 are described separately for convenience in describing the blank 900. Cut line 1072 is also co-planar with cut line 940.

Cut line 1074 is perpendicular to cut line 1072 and parallel to fold lines 918, 1058. Cut line 1074 extends outwardly from cut line 1072 to cut line 1076. Cut line 1074 is separated from fold line 918 by a distance of three and one-quarter (3.25) inches. Cut line 1074 is provided one-quarter (0.25) inches below where fold line 1058 is provided when viewed as in FIG. 1.

Cut line 1076 extends angularly upwardly and outwardly from cut line 1074 to fold line 1078.

Fold line 1078 is parallel to fold lines 918, 1074 and perpendicular to cut line 1056. Fold line 1078 extends outwardly from cut line 1076 to edge 1080. Fold line 1078 is separated from cut line 1056 by one and one-half (1.5) inches. Fold line 1078 is separated from fold line 918 by two and five-eighth (2.625) inches. Fold line 1078 is provided three-eighths (0.375) inches above where fold line 1058 is provided, and five-eighths (0.625) inches above where cut line 1074 is provided, when viewed as in FIG. 1.

Edge 1080 is perpendicular to fold lines 918, 1078 and cut line 1074, and is parallel to cut lines 1048, 1056. Edge 1080 extends upwardly from fold line 1078 to the intersection of cut line 994 and edge 996. Edge 1080 is separated from cut lines 1048, 1056 by a distance of three and three-sixteenths (3.1875) inches.

The third intermediate panel 1070 has a tab portion 1075 which is generally defined by the cut lines 1056, 1072, 1074, 1076.

The blank 900 has a fourth intermediate panel 1082 which is defined by fold line 960, cut lines 1052, 1068, 1084, 1086, 1088, fold line 1090, edge 1092, and cut line 1032.

Cut line 1084 extends downwardly from the intersection of cut line 1068 and fold line 1066 to cut line 1086. Cut line 1084 is co-planar with cut lines 968, 1052, 1068 such that cut lines 968, 1052, 1068, 1084 generally form a single cut line, but cut lines 968, 1052, 1068, 1084 are described separately for convenience in describing the blank 900. Cut line 1084 is also co-planar with cut line 944.

Cut line 1086 is perpendicular to cut line 1084 and parallel to fold lines 966, 1066. Cut line 1086 extends outwardly from cut line 1084 to cut line 1088. Cut line 1086 is separated from fold line 966 by a distance of three and one-quarter (3.25) inches. Cut line 1086 is provided one-quarter (0.25) inches below where fold line 1066 is provided when viewed as in FIG. 1.

Cut line 1088 extends angularly upwardly and outwardly from cut line 1086 to fold line 1090.

Fold line 1090 is parallel to fold lines 966, 1086 and perpendicular to cut line 1068. Fold line 1090 extends outwardly from cut line 1088 to edge 1092. Fold line 1090 is separated from cut line 1068 by one and one-half (1.5) inches. Fold line 1090 is separated from fold line 966 by two and five-eighth (2.625) inches. Fold line 1090 is provided three-eighths (0.375) inches above where fold line 1066 is provided, and five-eighths (0.625) inches above where cut line 1086 is provided, when viewed as in FIG. 1.

Edge 1092 is perpendicular to fold lines 966, 1090 and cut line 1086, and is parallel to cut lines 1052, 1068. Edge 1092 extends upwardly from fold line 1090 to the intersection of cut line 1032 and edge 1034. Edge 1092 is separated from cut lines 1052, 1068 by a distance of three and three-sixteenths (3.1875) inches. Edge 1092 is separated from edge 1080 by a distance of twelve and three-eighths (12.375) inches.

The fourth intermediate panel 1082 has a tab portion 1087 which is generally defined by the cut lines 1068, 1084, 1086, 1088.

The blank 900 has a first top panel 1094 which is defined by edges 1096, 1098, 1100, 1102, 1104, 1106, 1108, 1110, 1112, 1114, 1116, fold line 1078, cut lines 1076, 1118, 1120, 1122, 1072, fold line 1058, cut lines 1060, 1062, 1064, fold line 1066, cut lines 1084, 1124, 1126, 1128, 1088, and fold line 1090.

Edge 1096 extends downwardly from the intersection of fold line 1090 and edge 1092 for a distance of four and thirteen-sixteenths (4.8125) inches to edge 1098. Edge 1096 is co-planar with edge 1092 such that edges 1092, 1096 generally form a single edge, but edges 1092, 1096 are described separately for convenience in describing the blank 900.

Edge 1098 is perpendicular to edge 1096 and parallel to fold line 1090. Edge 1098 extends inwardly from edge 1096 for a distance of three and three-sixteenths (3.1875) inches to edge 1100. Edge 1098 is separated from fold line 1090 by a distance of four and thirteen-sixteenths (4.8125) inches.

Edge 1100 is perpendicular to edge 1098 and parallel to edge 1096. Edge 1100 extends upwardly from edge 1098 for a distance of three-eighths (0.375) inches to edge 1102. Edge 1100 is separated from edge 1098 by a distance of three and three-sixteenths (3.1875) inches.

Edge 1102 is perpendicular to edge 1100 and parallel to fold line 1066 and edge 1098. Edge 1102 extends inwardly from edge 1100 for a distance of one and three-quarter (1.75) inches to edge 1104. Edge 1102 is separated from fold line 1066 by four and one-sixteenth (4.0625) inches.

Edge 1104 is perpendicular to edge 1102 and parallel to edge 1100. Edge 1104 extends upwardly from edge 1102 for a distance of five-sixteenth (0.3125) inches to edge 1106. Edge 1104 is separated from edge 1098 by a distance of four and fifteen-sixteenth (4.9375) inches.

Edge 1106 is perpendicular to edge 1104 and parallel to edge 1102 and cut line 1062. Edge 1106 extends inwardly from edge 1004 for a distance of one and one-quarter (1.25) inches to the vertical centerline Y-Y and then outwardly from the vertical centerline Y-Y for a distance of one and one-quarter (1.25) inches to edge 1108. Edge 1106 is separated from cut line 1062 by a distance of three and nine-sixteenth (3.5625) inches.

Edge 1108 is perpendicular to edge 1106 and parallel to edge 1104. Edge 1108 extends downwardly from edge 1106 for a distance of five-sixteenth (0.3125) inches to edge 1110. Edge 1108 is separated from edge 1104 by a distance of two and one-half (2.5) inches.

Edge 1110 is perpendicular to edge 1108, parallel to edge 1106, and co-planar with edge 1102. Edge 1110 extends outwardly from edge 1108 for a distance of one and three-quarter (1.75) inches to edge 1112. Edge 1110 is separated from fold line 1058 by a distance of four and one-sixteenth (4.0625) inches.

Edge 1112 is perpendicular to edge 1110 and parallel to edges 1100, 1104, 1108. Edge 1112 extends downwardly from edge 1110 for a distance of three-eighths (0.375) inches to edge 1114. Edge 1112 is separated from edge 1110 by a distance of six (6) inches.

Edge 1114 is perpendicular to edge 1112, parallel to edges 1102, 1106, 1110 and fold line 1078, and co planar with edge 1098. Edge 1114 extends outwardly from edge 1112 for a distance of three and three-sixteenths (3.1875) inches to edge 1116. Edge 1114 is separated from fold line 1078 by a distance of four and thirteen-sixteenths (4.8125) inches. Edges 1098, 1114 are the bottommost edges of the blank 900 as viewed in FIG. 1.

Edge 1116 extends upwardly from edge 1114 for a distance of four and thirteen-sixteenths (4.8125) inches to the intersection of fold line 1078 and edge 1080. Edge 1116 is co-planar with edge 1080 such that edges 1080, 1116 generally form a single edge, but edges 1080, 1116 are described separately for convenience in describing the blank 900. Edge 1116 is separated from edge 1096 by a distance of twelve and three-eighths (12.375) inches.

Cut line 1118 extends angularly downwardly and inwardly from the intersection of cut lines 1074, 1076 to cut line 1120. Cut line 1118 is co-planar with cut line 1076 such that cut lines 1076, 1118 generally form a single cut line, but cut lines 1076, 1118 are described separately for convenience in describing the blank 900.

Cut line 1120 extends inwardly from cut line 1118 to cut line 1122. Cut line 1120 is parallel to cut line 1074 and is separated from cut line 1074 by a distance of one-quarter (0.25) inches.

Cut line 1122 extends upwardly from cut line 1120 to the intersection of cut lines 1072, 1074. Cut line 1122 is co-planar with cut lines 916, 1048, 1056, 1072 such that cut lines 916, 1048, 1056, 1072, 1122 generally form a single cut line, but cut lines 916, 1048, 1056, 1072, 1122 are described separately for convenience in describing the blank 900. Cut line 1122 is also co-planar with cut line 940.

Cut line 1124 extends downwardly from the intersection of cut lines 1084, 1086 to cut line 1126. Cut line 1124 is co-planar with cut lines 968, 1052, 1068, 1084 such that cut lines 968, 1052, 1068, 1084, 1124 generally form a single cut line, but cut lines 968, 1052, 1068, 1084, 1124 are described separately for convenience in describing the blank 900. Cut line 1124 is also co-planar with cut line 944.

Cut line 1126 extends outwardly from cut line 1124 to cut line 1128. Cut line 1126 is parallel to cut line 1086 and is separated from cut line 1086 by a distance of one-quarter (0.25) inches.

Cut line 1128 extends angularly upwardly and outwardly from cut line 1126 to the intersection of cut lines 1086, 1088. Cut line 1128 is co-planar with cut line 1088 such that cut lines 1088, 1128 generally form a single cut line, but cut lines 1088, 1128 are described separately for convenience in describing the blank 900.

The blank 900 has a third aperture 1123 provided therethrough which is defined by the cut lines 1074, 1118, 1120, 1122 such that the third aperture 1123 is generally trapezoidal in configuration.

The blank 900 has a fourth aperture 1129 provided therethrough which is defined by the cut lines 1086, 1124, 1126, 1128 such that the fourth aperture 1129 is generally trapezoidal in configuration.

The blank 900 has a second bridge panel 1130 which has a first panel portion 1131, a second panel portion 1138, a third panel portion 1144, a fourth panel portion 1150, a fifth panel portion 1158, and a sixth panel portion 1164. The second and fifth panel portions 1138, 1158 generally form a V-panel 1165.

The first panel portion 1131 is defined by fold line 941, cut lines 940, 1132, fold line 1134 and cut line 1136. Cut line 1132 extends upwardly from the intersection of fold line 938 and cut line 940 for a distance of one and three-eighth (1.375) inches to fold line 1134. Cut line 1132 is co-planar with cut line 940 such that cut lines 940, 1132 generally form a single cut line, but cut lines 940, 1132 are described separately for convenience in describing the blank 900. Cut line 1132 is also co-planar with cut lines 916, 1048, 1056, 1072, 1122. Fold line 1134 extends inwardly from cut line 1132 for a distance of two (2) inches to cut line 1136. Fold line 1134 is perpendicular to cut line 1132 and parallel to fold lines 938, 941. Fold line 1134 is generally separated from fold line 941 by a distance of one and three-quarter (1.75) inches. Cut line 1136 extends downwardly from fold line 1134 for a distance of one and three-quarter (1.75) inches to the intersection of fold lines 941, 942. Cut line 1136 is perpendicular to fold lines 941, 942, 1134 and parallel to cut lines 940, 1132. Cut line 1136 is separated from cut lines 940, 1132 by a distance of two (2) inches.

The second panel portion 1138 is defined by fold line 942, cut line 1136, fold line 1140 and cut line 1142. Fold line 1140 extends inwardly from the intersection of fold line 1134 and cut line 1136 for a distance of one (1) inch to the vertical centerline Y-Y and then outwardly from the vertical centerline Y-Y for a distance of one (1) inch to cut line 1142. Fold line 1140 is perpendicular to cut line 1136, and parallel to fold line 942. Fold line 1140 is also co-planar with fold line 1134 such that fold lines 1134, 1140 generally form a single cut line, but fold lines 1134, 1140 are described separately for convenience in describing the blank 900. Cut line 1142 extends downwardly from fold line 1140 for a distance of one and three-quarter (1.75) inches to the intersection of fold lines 942, 943. Cut line 1142 is perpendicular to fold lines 942, 943, 1140 and parallel to cut line 1136. Cut line 1142 is separated from cut line 1136 by a distance of two (2) inches.

The third panel portion 1144 is defined by fold line 943, cut line 1142, fold line 1146 and cut lines 1148, 944. Fold line 1146 extends outwardly from the intersection of fold line 1140 and cut line 1142 for a distance of two (2) inches to cut line 1148. Fold line 1146 is perpendicular to cut line 1142, and parallel to fold line 943. Fold line 1146 is also co-planar with fold lines 1134, 1140 such that fold lines 1134, 1140, 1146 generally form a single cut line, but fold lines 1134, 1140, 1146 are described separately for convenience in describing the blank 900. Cut line 1148 extends downwardly from fold line 1146 for a distance of one and three-eighths (1.375) inches to the intersection of cut line 944 and fold line 946. Cut line 1148 is perpendicular to fold lines 943, 946, 1146 and parallel to cut line 1142. Cut line 1148 is co-planar with cut line 944 such that cut lines 944, 1148 generally form a single cut line, but cut lines 944, 1148 are described separately for convenience in describing the blank 900. Cut line 1148 is also co-planar with cut lines 968, 1052, 1068, 1084, 1124. Cut lines 944, 1148 are separated from cut line 1142 by a distance of two (2) inches. Cut lines 944, 1148 are separated from cut lines 940, 1132 by a distance of six (6) inches.

The fourth panel portion 1150 is defined by fold line 1134, cut lines 1152, fold line 1154 and cut line 1156. Cut line 1152 extends upwardly from the intersection of cut line 1132 and fold line 1134 for a distance of one and three-quarter (1.75) inches to fold line 1154. Cut line 1152 is co-planar with cut lines 940, 1132 such that cut lines 940, 1132, 1152 generally form a single cut line, but cut lines 940, 1132, 1152 are described separately for convenience in describing the blank 900. Fold line 1154 extends inwardly from cut line 1152 for a distance of two (2) inches to cut line 1156. Fold line 1154 is perpendicular to cut line 1152 and parallel to fold lines 941, 1134. Fold line 1154 is generally separated from fold line 1134 by a distance of one and three-quarter (1.75) inches and from fold line 941 by a distance of thee and one-half (3.5) inches. Cut line 1156 extends downwardly from fold line 1154 for a distance of one and three-quarter (1.75) inches to the intersection of fold lines 1134, 1140. Cut line 1156 is perpendicular to fold lines 1134, 1140, 1154, and parallel to cut line 1152. Cut line 1156 is co-planar with cut line 1136 such that cut lines 1136, 1156 generally form a single cut line, but cut lines 1136, 1156 are described separately for convenience in describing the blank 900. Cut line 1156 is separated from cut lines 1152 by a distance of two (2) inches.

The fifth panel portion 1158 is defined by fold line 1140, cut line 1156, fold line 1160 and cut line 1162. Fold line 1160 extends inwardly from the intersection of fold line 1154 and cut line 1156 for a distance of one (1) inch to the vertical centerline Y-Y and then outwardly from the vertical centerline Y-Y for a distance of one (1) inch to cut line 1162. Fold line 1160 is perpendicular to cut line 1156, and parallel to fold line 1140. Fold line 1160 is also co-planar with fold line 1154 such that fold lines 1154, 1160 generally form a single cut line, but fold lines 1154, 1160 are described separately for convenience in describing the blank 900. Cut line 1162 extends downwardly from fold line 1160 for a distance of one and three-quarter (1.75) inches to the intersection of fold lines 1140, 1146. Cut line 1162 is perpendicular to fold lines 1140, 1146, 1160 and parallel to cut line 1156. Cut line 1162 is co-planar with cut line 1142 such that cut lines 1142, 1162 generally form a single cut line, but cut lines 1142, 1162 are described separately for convenience in describing the blank 900. Cut line 1162 is separated from cut line 1156 by a distance of two (2) inches.

The sixth panel portion 1164 is defined by fold line 1146, cut line 1162, fold line 1166 and cut line 1168. Fold line 1166 extends outwardly from the intersection of fold line 1160 and cut line 1162 for a distance of two (2) inches to cut line 1168. Fold line 1166 is perpendicular to cut line 1162, and parallel to fold line 1146. Fold line 1166 is also co-planar with fold lines 1154, 1160 such that fold lines 1154, 1160, 1166 generally form a single cut line, but fold lines 1154, 1160, 1166 are described separately for convenience in describing the blank 900. Cut line 1168 extends downwardly from fold line 1166 for a distance of one and three-quarter (1.75) inches to the intersection of fold line 1146 and cut line 1148. Cut line 1168 is perpendicular to fold lines 946, 1146, 1166 and parallel to cut line 1162. Cut line 1168 is co-planar with cut lines 944, 1148 such that cut lines 944, 1148, 1168 generally form a single cut line, but cut lines 944, 1148, 1168 are described separately for convenience in describing the blank 900. Cut line 1168 is separated from cut line 1162 by a distance of two (2) inches. Cut lines 1168 is separated from cut line 1152 by a distance of six (6) inches.

The blank 900 has a fifth intermediate panel 1170 which is defined by fold line 938, cut line 1002, edge 1172, cut line 1174, fold line 1176, and cut lines 1178, 1180, 1182, 1152, 1132.

The edge 1172 extends upwardly from the intersection of cut line 1002 and edge 1004 to cut line 1174. Edge 1172 is perpendicular to fold line 938, parallel to cut lines 1132, 1152, and co-planar with edges 1080, 1116.

The cut line 1174 extends upwardly from edge 1172 for a distance of one-half (0.5) inches to fold line 1176. Cut line 1174 is co-planar with edge 1172. Cut line 1174 and edge 1174 are separated from cut line 1152 by a distance of three and three-sixteenth (3.1875) inches.

Fold line 1176 extends inwardly from cut line 1174 to cut line 1178. Fold line 1176 is perpendicular to cut line 1174 and fold line 1172, and is parallel to fold line 938. Fold line 1176 is separated from fold line 938 by a distance of two and three-quarter (2.75) inches.

Cut line 1178 extends angularly upwardly and inwardly from fold line 1176 to cut line 1180.

Cut line 1180 extends inwardly from cut line 1178 to cut line 1182. Cut line 1180 is perpendicular to cut lines 1152, 1174, and parallel to fold lines 938, 1154, 1176. Cut line 1180 is separated from fold line 938 by a distance of three and one-quarter (3.25) inches.

Cut line 1182 extends downwardly from cut line 1180 for a distance of one-eighth (0.125) inches to cut line 1152. Cut line 1182 is co-planar with cut lines 940, 1132, 1152 such that cut lines 940, 1132, 1152, 1182 generally form a single cut line, but cut lines 940, 1132, 1152, 1182 are described separately for convenience in describing the blank 900

The fifth intermediate panel 1170 has a tab portion 1181 which is generally defined by the cut lines 1178, 1180, 1182, 1152.

The blank 900 has a sixth intermediate panel 1184 which is defined by fold line 946, cut line 1040, edge 1186, cut line 1188, fold line 1190, and cut lines 1192, 1194, 1196, 1168, 1148.

The edge 1186 extends upwardly from the intersection of cut line 1040 and edge 1042 to cut line 1188. Edge 1186 is perpendicular to fold line 946, parallel to cut lines 1148, 1168 and edge 1172, and co-planar with edges 1092, 1096. Edge 1186 is separated from edge 1172 by a distance of twelve and three-eighth (12.375) inches.

The cut line 1188 extends upwardly from edge 1186 for a distance of one-half (0.5) inches to fold line 1190. Cut line 1188 is parallel to cut line 1174 and co-planar with edge 1186. Cut line 1188 and edge 1186 are separated from cut line 1168 by a distance of three and three-sixteenth (3.1875) inches. Cut line 1188 is separated from cut line 1174 by a distance of twelve and three-eighth (12.375) inches.

Fold line 1190 extends inwardly from cut line 1188 to cut line 1192. Fold line 1190 is perpendicular to cut line 1188 and fold line 1186, parallel to fold line 946, and co-planar with fold line 1176. Fold line 1190 is separated from fold line 946 by a distance of two and three-quarter (2.75) inches.

Cut line 1192 extends angularly upwardly and inwardly from fold line 1190 to cut line 1194.

Cut line 1194 extends inwardly from cut line 1192 to cut line 1196. Cut line 1194 is perpendicular to cut lines 1168, 1188, parallel to fold lines 946, 1166, 1190, and co-planar with cut line 1180. Cut line 1194 is separated from fold line 946 by a distance of three and one-quarter (3.25) inches.

Cut line 1196 extends downwardly from cut line 1194 for a distance of one-eighth (0.125) inches to cut line 1168. Cut line 1196 is co-planar with cut lines 944, 1148, 1168 such that cut lines 944, 1148, 1168, 1196 generally form a single cut line, but cut lines 944, 1148, 1168, 1196 are described separately for convenience in describing the blank 900. Cut line 1196 is parallel with cut line 1182 by a distance of six (6) inches.

The sixth intermediate panel 1184 has a tab portion 1195 which is generally defined by the cut lines 1192, 1194, 1196, 1168.

The blank 900 has a second top panel 1198 which is defined by fold lines 1199, 1200, cut lines 1202, 1204, 1206, 1208, 1210, fold line 1212, edges 1214, 1216, 1218, 1220, 1222, cut line 1224, fold line 1226, cut line 1228, edges 1230, 1232, 1234, 1236, 1238, fold line 1240, cut lines 1242, 1244, 1246, 1248, 1250, fold lines 1252, 1253, 1190, cut lines 1192, 1254, 1256, 1258 1196, fold lines 1166, 1160, 1154, cut lines 1182, 1260, 1262, 1264, 1178, and fold line 1176.

Fold line 1199 extends outwardly from the intersection of cut line 1174 and fold line 1176 for a distance of one-sixteenth (0.0625) inches to fold line 1200. Fold line 1199 is perpendicular to cut line 1174 and is co-planar with fold line 1176 such that fold lines 1176, 1199 generally form a single fold line, but fold lines 1176, 1199 are described separately for convenience in describing the blank 900.

Fold line 1200 extends upwardly from fold line 1199 to cut line 1202. Fold line 1200 is perpendicular to fold lines 1176, 1199 and parallel to cut line 1174.

Cut line 1202 extends angularly upwardly and inwardly from fold line 1200 to cut line 1204. Cut line 1202 is parallel to cut lines 924, 926, 952, 954.

Cut line 1204 extends angularly upwardly and inwardly from cut line 1202 to cut line 1206. Cut line 1204 is parallel to cut lines 924, 926, 952, 954 and is co-planar with cut line 1202 such that cut lines 1202, 1204 generally form a single cut line, but cut line, but cut lines 1202, 1204 are described separately for convenience in describing the blank 900.

Cut line 1206 extends upwardly from cut line 1204 to cut line 1208. Cut line 1206 is parallel to fold line 1200.

Cut line 1208 extends angularly upwardly and outwardly from cut line 1206 to cut line 1210. Cut line 1208 is parallel to cut lines 930, 932, 958, 960.

Cut line 1210 extends angularly upwardly and outwardly from cut line 1208 to cut line 1212. Cut line 1210 is parallel to cut lines 930, 932, 958, 960 and is co-planar with cut line 1208 such that cut lines 1208, 1210 generally form a single cut line, but cut line, but cut lines 1208, 1210 are described separately for convenience in describing the blank 900.

Fold line 1212 extends upwardly from cut line 1210 to edge 1214. Fold line 1212 is parallel to cut line 1206 and is co-planar with fold line 1200. Fold line 1212 is separated from fold line 1200 by a distance of one and one-half (1.5) inches.

Edge 1214 extends inwardly from fold line 1212 for a distance of one and three-quarter (1.75) inches to edge 1216. Edge 1214 is perpendicular to fold line 1212 and parallel to fold line 1176. Edge 1214 is separated from fold line 1176 by a distance of five and thirteen-thirty-seconds (5.03125) inches.

Edge 1216 extends downwardly from edge 1214 for a distance of nineteen-thirty-seconds (0.03125) inches to edge 1218. Edge 1216 is perpendicular to edge 1214 and parallel to fold line 1212. Edge 1216 is separated from fold line 1212 by a distance of one and three-quarter (1.75) inches.

Edge 1218 extends inwardly from edge 1216 for a distance of one and one-half (1.5) inches to edge 1220. Edge 1218 is perpendicular to edge 1216 and parallel to edge 1214 and cut line 1262.

Edge 1220 extends downwardly from edge 1218 to edge 1222. Edge 1220 is perpendicular to edge 1218, parallel to edge 1216 and fold line 1212, and co-planar with cut lines 916, 1048, 1056, 1072, 1122 and cut lines 940, 1132, 1152, 1182, 1260. Edge 1220 is separated from fold line 1212 by a distance of three and one-quarter (3.25) inches.

Edge 1222 extends inwardly from edge 1220 for a distance of two (2) inches to cut line 1224. Edge 1222 is perpendicular to edge 1220 and is parallel to edge 1218 and fold line 1154. Edge 1222 is separated from fold line 1154 by a distance of three and fifteen-sixteenths (3.9375) inches.

Cut line 1224 extends downwardly from edge 1222 for a distance of one (1) inch to fold line 1226. Cut line 1224 is perpendicular to edge 1222, parallel to fold line 1212 and edge 1220, and co-planar with cut lines 1136, 1156.

Fold line 1226 extends inwardly from cut line 1224 for a distance of one (1) inch to the vertical centerline Y-Y and then outwardly from the vertical centerline Y-Y for a distance of one (1) inch to cut line 1228. Fold line 1226 is perpendicular to cut line 1224 and parallel to edge 1222 and fold line 1160. Fold line 1226 is separated from fold line 1160 by a distance of two and fifteen-sixteenths (2.9375) inches.

Cut line 1228 extends upwardly from fold line 1226 for a distance of one (1) inch to cut line 1230. Cut line 1230 is perpendicular to fold line 1226, parallel to cut line 1224, and co-planar with cut lines 1142, 1162. Cut line 1228 is separated from cut line 1224 by a distance of two (2) inches.

Edge 1230 extends outwardly from cut line 1228 for a distance of two (2) inches to edge 1232. Edge 1230 is perpendicular to cut line 1228, is parallel to fold lines 1166, 1226, and is co-planar with edge 1222. Edge 1230 is separated from fold line 1166 by a distance of three and fifteen-sixteenths (3.9375) inches.

Edge 1232 extends upwardly from edge 1230 to edge 1234. Edge 1232 is perpendicular to edge 1230, parallel to cut line 1228, and co-planar with cut lines 968, 1052, 1068, 1084, 1124 and cut lines 944, 1148, 1168, 1196, 1258.

Edge 1234 extends outwardly from edge 1232 for a distance of one and one-half (1.5) inches to edge 1236. Edge 1234 is perpendicular to edge 1232, parallel to edge 1230 and cut line 1256, and co-planar with edge 1218.

Edge 1236 extends upwardly from edge 1234 for a distance of nineteen-thirty-seconds (0.03125) inches to edge 1238. Edge 1236 is perpendicular to edge 1234 and parallel to edge 1232.

Edge 1238 extends outwardly from edge 1236 for a distance of one and three-quarter (1.75) inches to fold line 1240. Edge 1238 is perpendicular to edge 1236 and parallel to fold line 1190. Edge 1238 is separated from fold line 1190 by a distance of five and thirteen-thirty-seconds (5.03125) inches. Edge 1238 is co-planar with edge 1214. Edges 1214, 1238 define the uppermost edges of the blank 900 as viewed in FIG. 1.

Fold line 1240 extends downwardly from edge 1238 to cut line 1242. Fold line 1240 is perpendicular to edge 1238 and parallel to edges 1232, 1236, cut lines 1224, 1228 and fold line 1212. Fold line 1240 is separated from edge 1236 by a distance of one and three-quarter (1.75) inches. Fold line 1240 is separated from edge 1232 by a distance of three and one-quarter (3.25) inches. Fold line 1240 is separated from cut line 1228 by a distance of five and one-quarter (5.25) inches. Fold line 1240 is separated from fold line 1212 by a distance of twelve and one-half (12.5) inches.

Cut line 1242 extends angularly downwardly and inwardly from fold line 1240 to cut line 1244. Cut line 1242 is parallel to cut lines 924, 926, 952, 954, 1202, 1204.

Cut line 1244 extends angularly downwardly and inwardly from cut line 1242 to cut line 1246. Cut line 1244 is parallel to cut lines 924, 926, 952, 954, 1202, 1204 and is co-planar with cut line 1242 such that cut lines 1242, 1244 generally form a single cut line, but cut line, but cut lines 1242, 1244 are described separately for convenience in describing the blank 900.

Cut line 1246 extends downwardly from cut line 1244 to cut line 1248. Cut line 1246 is parallel to cut line 1206 and fold line 1240.

Cut line 1248 extends angularly downwardly and outwardly from cut line 1246 to cut line 1250. Cut line 1248 is parallel to cut lines 930, 932, 958, 960, 1208, 1210.

Cut line 1250 extends angularly downwardly and outwardly from cut line 1248 to fold line 1252. Cut line 1250 is parallel to cut lines 930, 932, 958, 960, 1208, 1210 and co-planar with cut line 1248 such that cut lines 1248, 1250 generally form a single cut line, but cut line, but cut lines 1248, 1250 are described separately for convenience in describing the blank 900.

Fold line 1252 extends downwardly from cut line 1250 to fold line 1253. Fold line 1252 is parallel to cut line 1246 and fold line 1200, and co-planar with fold line 1240. Fold line 1252 is separated from fold line 1240 by a distance of one and one-half (1.5) inches. Fold line 1252 is separated from fold line 1200 by a distance of twelve and one-half (12.5) inches.

Fold line 1253 extends inwardly from fold line 1252 for a distance of one-sixteenth (0.0625) inches to the intersection of cut line 1188 and fold line 1190. Fold line 1253 is perpendicular to cut line 1188 and fold line 1252 and is co-planar with fold line 1190 such that fold lines 1190, 1253 generally form a single fold line, but fold lines 1190, 1253 are described separately for convenience in describing the blank 900.

Cut line 1254 extends angularly upwardly and inwardly from the intersection of cut lines 1192, 1194 to cut line 1256. Cut line 1254 is co-planar with cut line 1192 such that cut lines 1192, 1254 generally form a single cut line, but cut lines 1192, 1254 are described separately for convenience in describing the blank 900.

Cut line 1256 extends inwardly from cut line 1254 to cut line 1258. Cut line 1256 is parallel to cut line 1194 and fold lines 1166, 1190.

Cut line 1258 extends downwardly from cut line 1256 to the intersection of cut lines 1194, 1196. Cut line 1258 is perpendicular to cut lines 1194, 1256 and is co-planar with cut lines 944, 1148, 1168, 1196 such that cut lines 944, 1148, 1168, 1196, 1256 generally form a single cut line, but cut lines 944, 1148, 1168, 1196, 1256 are described separately for convenience in describing the blank 900.

Cut line 1260 extends upwardly from the intersection of cut lines 1180, 1182 to cut line 1262. Cut line 1260 is perpendicular to cut line 1180, is parallel with cut line 1258, and is co-planar with cut lines 940, 1132, 1152, 1182 such that cut lines 940, 1132, 1152, 1182, 1260 generally form a single cut line, but cut lines 940, 1132, 1152, 1182, 1260 are described separately for convenience in describing the blank 900. Cut line 1260 is separated from cut line 1258 by a distance of six (6) inches.

Cut line 1262 extends angularly downwardly and outwardly from cut line 1260 to the intersection of cut lines 1178, 1180. Cut line 1262 is co-planar with cut line 1178 such that cut lines 1178, 1262 generally form a single cut line, but cut lines 1178, 1262 are described separately for convenience in describing the blank 900.

The blank 900 has a fifth aperture 1259 provided therethrough which is defined by the cut lines 1194, 1254, 1256, 1258 such that the fifth aperture 1259 is generally trapezoidal in configuration.

The blank 900 has a sixth aperture 1265 provided therethrough which is defined by the cut lines 1180, 1260, 1262, 1264 such that the sixth aperture 1265 is generally trapezoidal in configuration.

The blank 900 has a locking tab member 1266 which is defined by fold line 1226, cut line 1224, edges 1268, 1270, 1272, 1274, 1276, 1278, 1280, 1282, 1284, and cut line 1228.

Edge 1268 extends upwardly from the intersection of edge 1222 and cut line 1224 for a distance of three-sixteenth (0.1875) inches to edge 1270. Edge 1268 is perpendicular to edge 1222, parallel to edge 1220, and co-planar with cut line 1224. Edge 1268 is separated from edge 1220 by a distance of two (2) inches.

Edge 1270 extends outwardly from edge 1268 for a distance of one-eighth (0.125) inches to edge 1272. Edge 1270 is perpendicular to edge 1268 and parallel to edge 1222.

Edge 1272 extends upwardly from edge 1270 for a distance of one-quarter (0.25) inches to edge 1274. Edge 1272 is perpendicular to edge 1270 and parallel to edges 1220, 1268. Edge 1272 is separated from edge 1220 by a distance of one and seven-eighths (1.875) inches.

Edge 1274 extends angularly upwardly and inwardly from edge 1272 to edge 1276.

Edge 1276 extends inwardly from edge 1274 to the vertical centerline Y-Y and then outwardly from the vertical centerline Y-Y to edge 1278. Edge 1276 is perpendicular to edge 1272, parallel to fold line 1226, and coplanar with edges 1214, 1238. Edge 1276, along with edges 1214, 1238 define the uppermost edges of the blank 900 as viewed in FIG. 1.

Edge 1278 extends angularly downwardly and outwardly from edge 1276 to edge 1280.

Edge 1280 extends downwardly from edge 1278 for a distance of one-quarter (0.25) inches to edge 1282. Edge 1280 is perpendicular to edge 1276 and parallel to edges 1232, 1272. Edge 1280 is separated from edge 1272 by a distance of two and one-quarter (2.25) inches. Edge 1280 is separated from edge 1232 by a distance of one and seven-eighth (1.875) inches.

Edge 1282 extends inwardly from edge 1280 for a distance of one-eighth (0.125) inches to edge 1284. Edge 1282 is perpendicular to edge 1280, parallel to edges 1230, 1276, and co-planar with edge 1270. Edge 1282 is separated from edge 1230 by a distance of three-sixteenth (0.1875) inches.

Edge 1284 extends downwardly from edge 1282 for a distance of three-sixteenth (0.1875) inches to the intersection of cut line 1228 and edge 1230. Edge 1284 is perpendicular to edges 1230, 1282, parallel to edges 1232, 1268, and co-planar with cut line 1228. Edge 1284 is separated from edge 1230 by a distance of two (2) inches. Edge 1284 is separated from edge 1268 by a distance of two (2) inches.

The locking tab member 1266 is further provided with a fold line 1286 which extends from the intersection of cut line 1224 and edges 1222, 1268 for a distance of two (2) inches to the intersection of cut line 1228 and edges 1230, 1284. Fold line 1286 is parallel to fold line 1226 and edge 1276 and is parallel to edges 1222, 1230.

The blank 900 has a third side panel 1288 which is defined by edges 1290, 1292, 1294, 1296, 1298, fold line 1212, cut lines 1210, 1299, 1202, fold lines, 1200, 1199 and cut line 1174.

Edge 1290 extends outwardly from the intersection of edge 1172 and cut line 1174 for a distance of 2.75 inches to edge 1292. Edge 1290 is perpendicular to edge 1172 and cut line 11174 and parallel to edges 990, 1004.

Edge 1292 extends angularly upwardly and outwardly from edge 1290 to edge 1294.

Edge 1294 extends upwardly from edge 1292 for a distance of three and fifteen-sixteenths (3.9375) inches to edge 1296. Edge 1294 is perpendicular to edge 1290, parallel to fold lines 1200, 1212 and cut line 1206, and co-planar with edge 988. Edge 1294, along with edge 988, are the leftmost edges of the blank 900 as viewed in FIG. 1. Edge 1294 is separated from fold lines 1200, 1212 by a distance of three and one-quarter (3.25) inches.

Edge 1296 extends angularly upwardly and inwardly from edge 1294 to edge 1298.

Edge 1298 extends inwardly from edge 1296 for a distance of two and three-quarter (2.75) inches to the intersection of fold line 1212 and edge 1214. Edge 1298 is perpendicular to edge 1294 and fold line 1212, parallel to edge 1290, and co-planar with edges 1214, 1238. Edge 1298, along with edges 1214, 1238, are the uppermost edges of the blank 900 as viewed in FIG. 1. Edge 1298 is separated from edge 1290 by a distance of five and fifteen-sixteenths (5.9375) inches.

Cut line 1299 extends downwardly from the intersection of cut lines 1208, 1210 to the intersection of cut lines 1202, 1204. Cut line 1299 is parallel to cut line 1206, fold lines 1200, 1212 and edge 1294. Cut line 1299 is separated from edge 1294 by a distance of three and three-quarter (3.75) inches.

The third side panel 1288 has a tab portion 1300 which is generally defined by the cut lines 1202, 1299, 1210.

The blank 900 has a seventh aperture 1301 provided therethrough which is defined by the cut lines 1204, 1206, 1208, 1299 such that the seventh aperture 1301 is generally trapezoidal in configuration.

The blank 900 has a fourth side panel 1302 which is defined by edges 1304, 1306, 1308, 1310, 1312, fold line 1240, cut lines 1242, 1313, 1250, fold lines 1252, 1253 and cut line 1188.

Edge 1304 extends outwardly from the intersection of edge 1186 and cut line 1188 for a distance of two and three-quarter (2.75) inches to edge 1306. Edge 1304 is perpendicular to edge 1186 and cut line 1188, parallel to edges 1028, 1042, and co-planar with edge 1290. Edge 1304 is separated from edge 1290 by a distance of twelve and three-eighth (12.375) inches.

Edge 1306 extends angularly upwardly and outwardly from edge 1304 to edge 1308. Edge 1306 is parallel to edge 1296.

Edge 1308 extends upwardly from edge 1306 for a distance of three and fifteen-sixteenths (3.9375) inches to edge 1310. Edge 1308 is perpendicular to edge 1304, parallel to fold lines 1240, 1252, cut line 1246 and edge 1294, and co-planar with edge 1026. Edge 1308, along with edge 1026, are the rightmost edges of the blank 900 as viewed in FIG. 1. Edge 1308 is separated from fold lines 1240, 1252 by a distance of three and one-quarter (3.25) inches. Edge 1308 is separated from edge 1294 by a distance of nineteen (19) inches.

Edge 1310 extends angularly upwardly and inwardly from edge 1308 to edge 1312. Edge 1310 is parallel to edge 1292.

Edge 1312 extends inwardly from edge 1310 for a distance of two and three-quarter (2.75) inches to the intersection of fold line 1240 and edge 1238. Edge 1312 is perpendicular to edge 1308 and fold line 1240, parallel to edge 1304, and co-planar with edges 1214, 1238, 1298. Edge 1312, along with edges 1214, 1238, 1298, are the uppermost edges of the blank 900 as viewed in FIG. 1. Edge 1312 is separated from edge 1304 by a distance of five and fifteen-sixteenths (5.9375) inches.

Cut line 1313 extends downwardly from the intersection of cut lines 1242, 1244 to the intersection of cut lines 1248, 1250. Cut line 1313 is parallel to cut lines 1246, 1299, fold lines 1240, 1252 and edge 1308. Cut line 1313 is separated from edge 1308 by a distance of three and three-quarter (3.75) inches. Cut line 1313 is separated from cut line 1299 by a distance of eleven and one-half (11.5) inches.

The fourth side panel 1302 has a tab portion 1314 which is generally defined by the cut lines 1242, 1313, 1250.

The blank 900 has an eighth aperture 1315 provided therethrough which is defined by the cut lines 1244, 1246, 1248, 1313 such that the eighth aperture 1315 is generally trapezoidal in configuration.

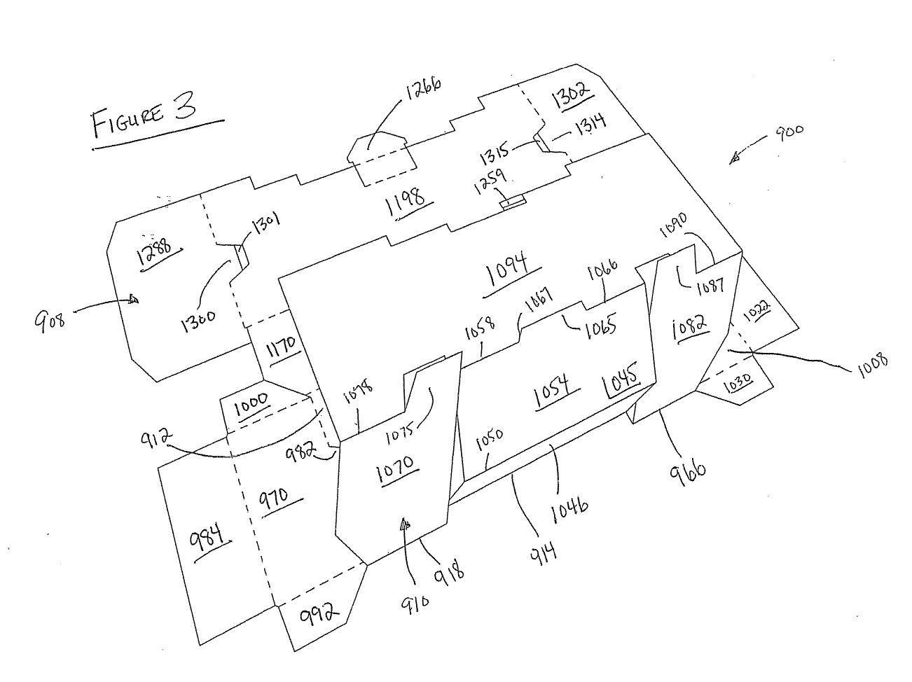

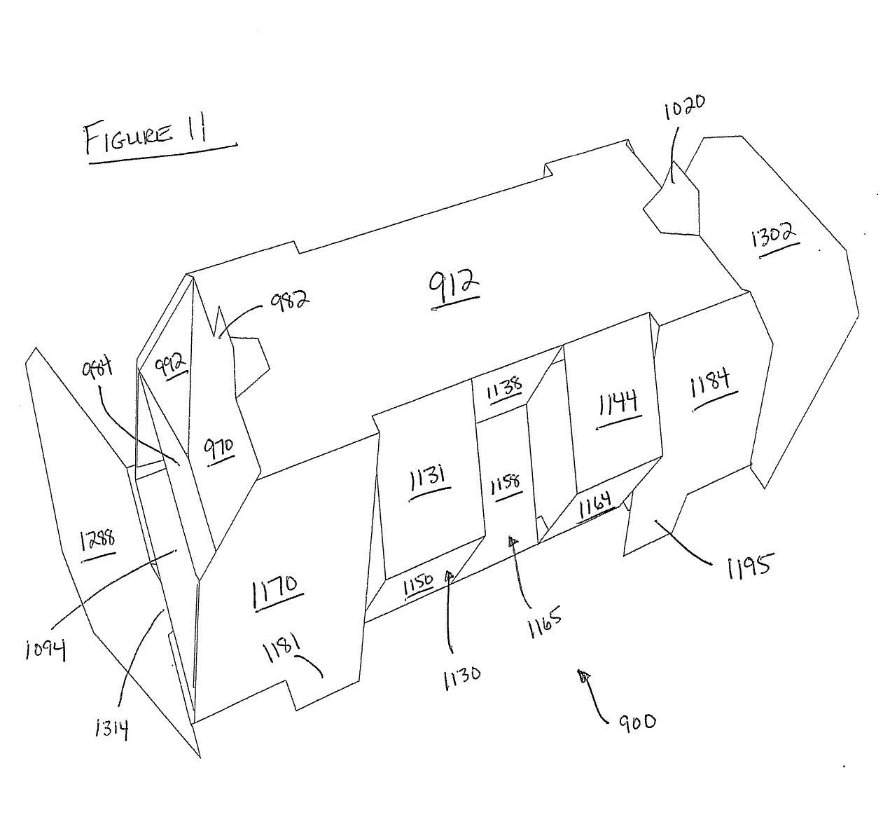

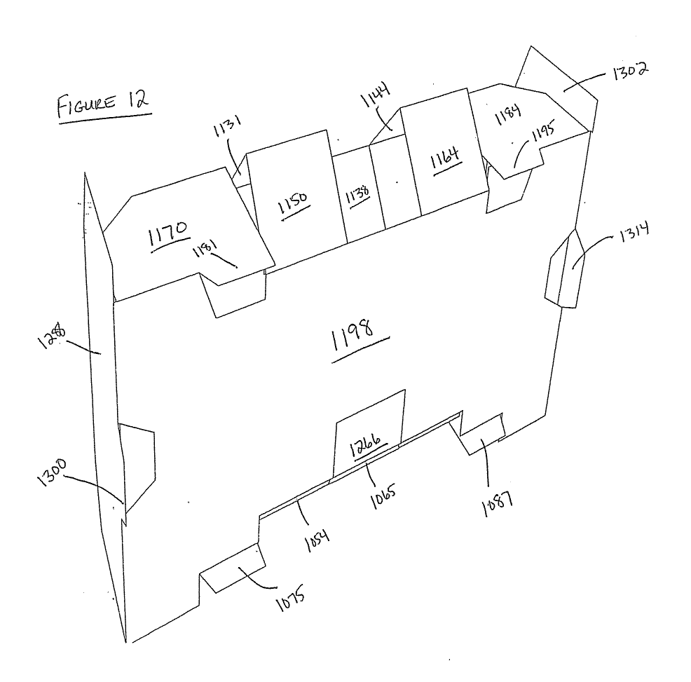

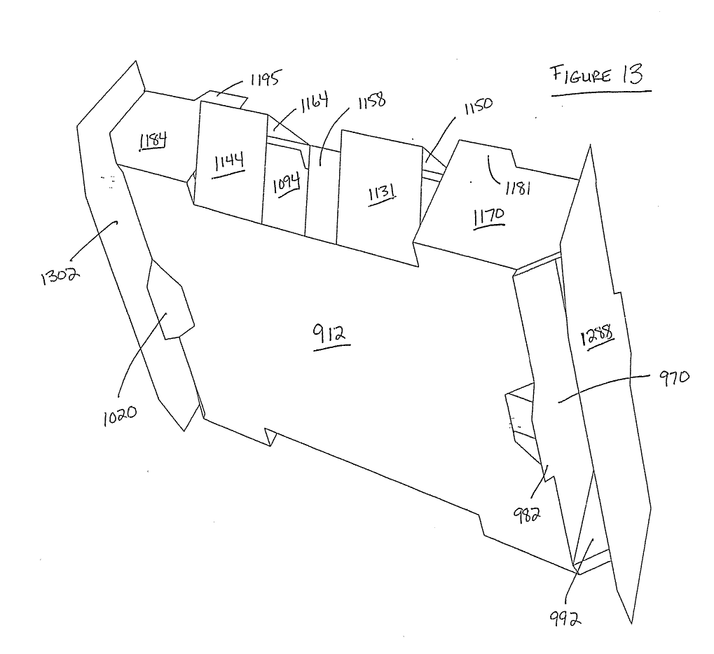

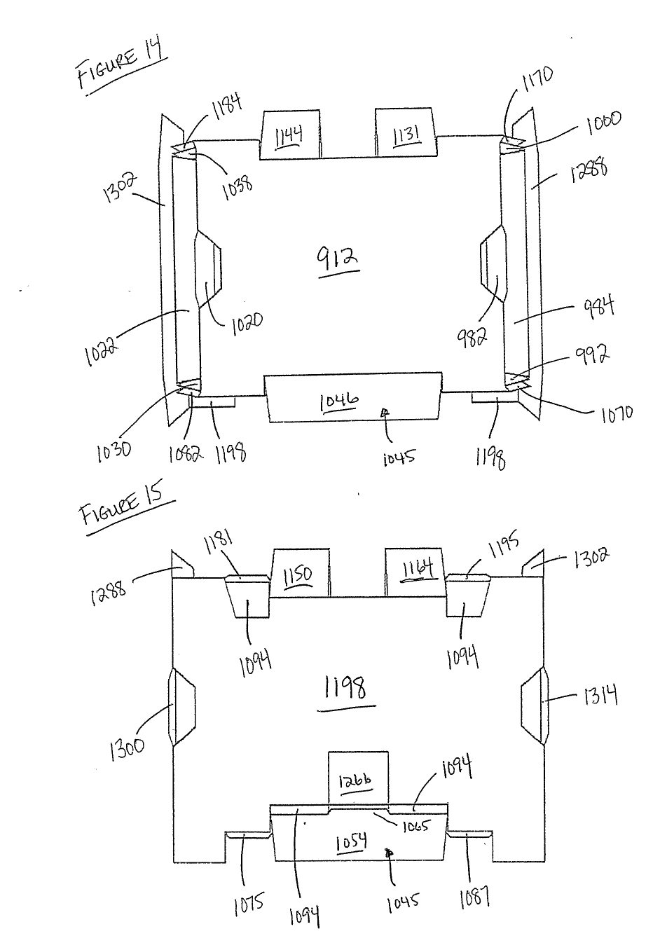

Attention is now directed to FIGS. 3-17 which illustrate the blank 900 being folded to form the insert 902 for receiving, protecting and securing the product 904, such as a toner cartridge.

As illustrated in FIG. 3, the first top panel 1094 is folded upwardly relative to the third intermediate panel 1070, along fold line 1078, relative to the fourth intermediate panel 1082, along fold line 1090, and relative to the first bridge panel 1045, along fold lines 1058, 1066. The first top panel 1094 is folded until it is parallel to, and positioned over, the base panel 912, such that the top surface 908 of the first top panel 1094 faces the top surface 908 of the base panel 912.

By folding the first top panel 1094 in this manner, the third and fourth intermediate panels 1070, 1082 are also folded upwardly relative to the base panel 912 along fold lines 918, 966, respectively, until the third and fourth intermediate panels 1070, 1082 are positioned perpendicular to the base panel 912, with the first top panel 1094 being positioned perpendicular to the third and fourth intermediate panels 1070, 1082. The tab portions 1075, 1087 are thus also positioned perpendicular to the first top panel 1094 and extend beyond the bottom surface 910 of the first top panel 1094.

Also, by folding the first top panel 1094 and the third and fourth intermediate panels 1070, 1082 in this manner, the first bridge panel 1045 is folded along fold lines 914, 1050, 1058, 1066, such that the first panel portion 1046 extends angularly outwardly and upwardly from fold line 914 to fold line 1050, and such that the second panel portion 1054 extends angularly outwardly and downwardly from fold lines 1058, 1066 to fold line 1050. Thus, fold line 1050 provides a peak portion of the first bridge panel 1045. The folding of the second panel portion 1054 also provides an aperture 1067 in the place where the tab portion 1065 had been positioned.

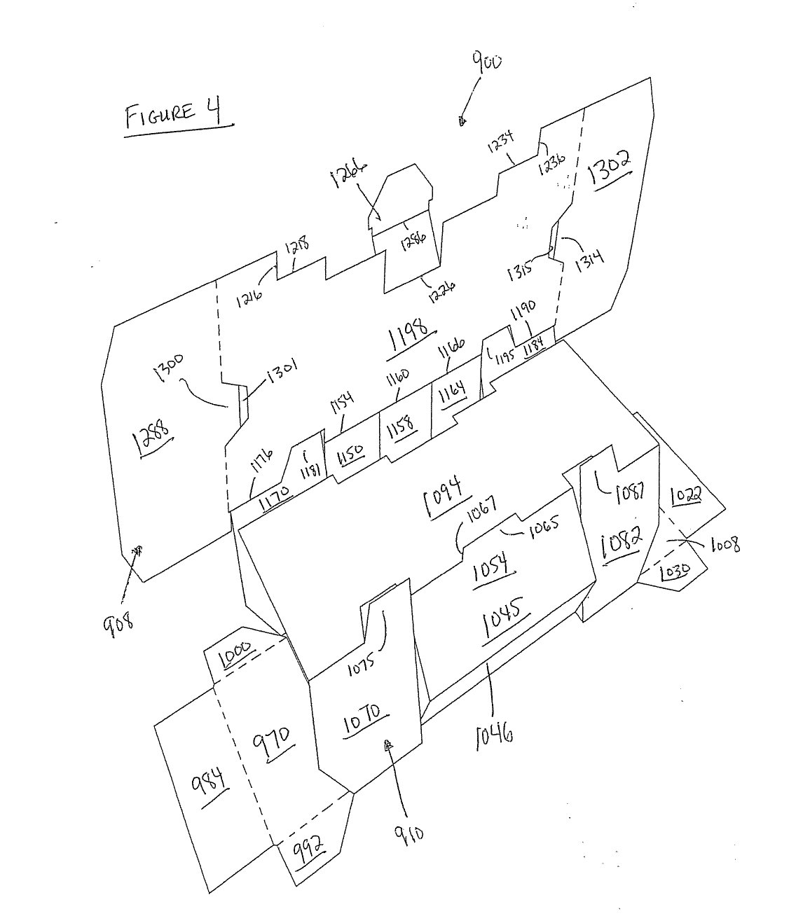

As illustrated in FIGS. 4-6, the second top panel 1198 is folded upwardly relative to the fifth intermediate panel 1170, along fold line 1176, relative to the sixth intermediate panel 1184, along fold line 1190, and relative to the second bridge panel 1130, along fold lines 1154, 1160, 1166. The second top panel 1198 is folded until it is parallel to, and positioned over, the first top panel 1094, such that the top surface 908 of the second top panel 1198 faces the bottom surface 910 of the first top panel 1094.

By folding the second top panel 1198 in this manner, the fifth and sixth intermediate panels 1170, 1184 are also folded upwardly relative to the base panel 912 along fold lines 938, 946, respectively, until the fifth and sixth intermediate panels 1170, 1184 are positioned perpendicular to the base panel 912, with the second top panel 1198 being positioned perpendicular to the fifth and sixth intermediate panels 1170, 1184. The tab portions 1181, 1195 are thus also positioned perpendicular to the second top panel 1198 and extend beyond the bottom surface 910 of the second top panel 1198. The fifth intermediate panel 1170 is thus parallel to the third intermediate panel 1070 such that the top surfaces 918 of the third and fifth intermediate panels 1070, 1170 face one another. The sixth intermediate panel 1184 is thus parallel to the fourth intermediate panel 1082 such that the top surface 918 of the fourth and sixth intermediate panels 1082, 1184 face one another.

Also, by folding the second top panel 1198 and the fifth and sixth intermediate panels 1170, 1184 in this manner, the second bridge panel 1130 is folded along fold lines 941, 942, 943, 1134, 1140, 1146, 1154, 1160, 1166, such that the first, second and third panel portions 1131, 1138, 1144 extend angularly outwardly and upwardly from fold lines 941, 942, 943 to fold lines 1134, 1140, 1146, and such that the fourth, fifth and sixth panel portions 1150, 1158, 1164 extends angularly outwardly and downwardly from fold lines 1154, 1160, 1166 to fold lines 1134, 1140, 1146. Thus, fold lines 1134, 1140, 1146 provide a peak portion of the second bridge panel 1130.

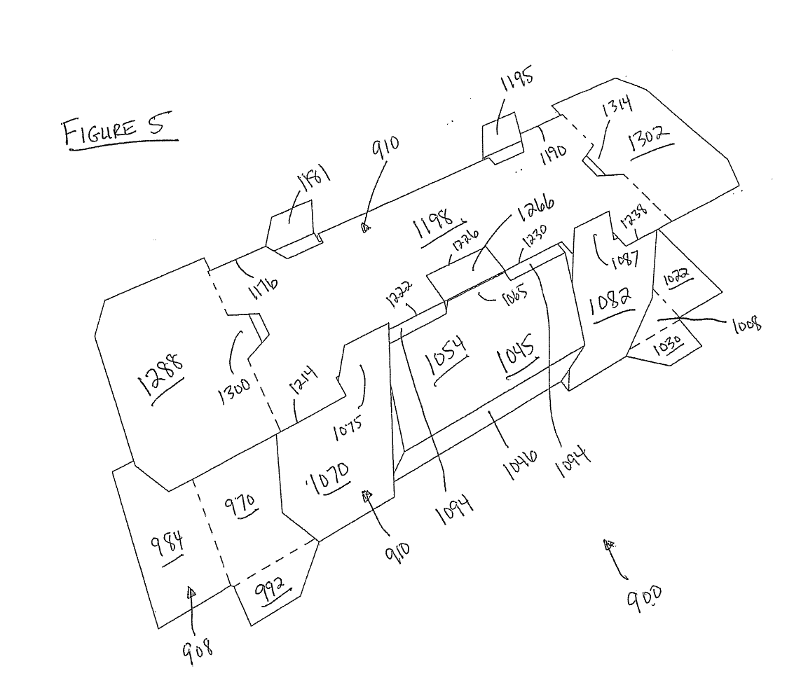

The locking tab member 1266 is also folded along fold lines 1226, 1286 such that it can be inserted into the aperture 1067 provided in the place where the tab portion 1065 had been positioned. The locking tab member 1266 thus locks the blank 900 in the position as described and as illustrated in FIGS. 5 and 6. With the locking tab member 1266 locked into the aperture 1067, the top surface 908 of the second top panel 1198 is generally positioned against the bottom surface 910 of the first top panel 1094. The edge 1218 is positioned against the top surface 908 of the tab portion 1075 of the third intermediate panel 1070 such that edge 1214 extends beyond the bottom surface 910 of the third intermediate panel 1070 such that the edge 1214 is generally co-planar with fold line 1050. Likewise, the edge 1234 is positioned against the top surface 908 of the tab portion 1082 of the fourth intermediate panel 1082 such that edge 1238 extends beyond the bottom surface 910 of the fourth intermediate panel 1082 such that the edge 1238 is generally co-planar with fold line 1050.

Thus, the blank 900, as currently folded, generally has a cross-section which is six-sided or hexagonal in configuration if the cross-section is taken about the first and second bridge panels 1045, 1130, but generally has a cross-section which is four-sided or quadrilateral in configuration if the cross-section is taken about either the third and fifth intermediate panels 1070, 1170 or the fourth and sixth intermediate panels 1082, 1184. An opening 903 is thus provided through the folded blank 900, which is open at both ends of the opening 903.

When the blank 900 is in the folded position as illustrated in FIGS. 5 and 6, the product 904 may then be inserted into the opening 903 of the blank 900, as illustrated in FIG. 6 (the product 904 is generally illustrated as a rectangular box, but it is to be understood that this is merely a generalization and that the product 904 can take on numerous different shapes), from either end, namely a first end defined by the first and third side panels 984, 1288, the first intermediate panel 970 and the first and second wing panels 992, 1000, or a second end defined by the second and fourth side panels 1022, 1302, the second intermediate panel 1008 and the third and fourth wing panels 1030, 1038, such that the product 904 is generally encapsulated between the base panel 512, the first and second bridge panels 1045, 1130, the third, fourth, fifth and sixth intermediate panels 1070, 1082, 1170, 1184, and the first top panel 1094. If desired, the product 904 could, conversely, be placed on the top surface 908 of the base panel 912 prior to the folding of the blank 900 such that the product 904 would already be positioned within the opening 903 when the blank 900 is folded in the manner illustrated in FIGS. 5 and 6.

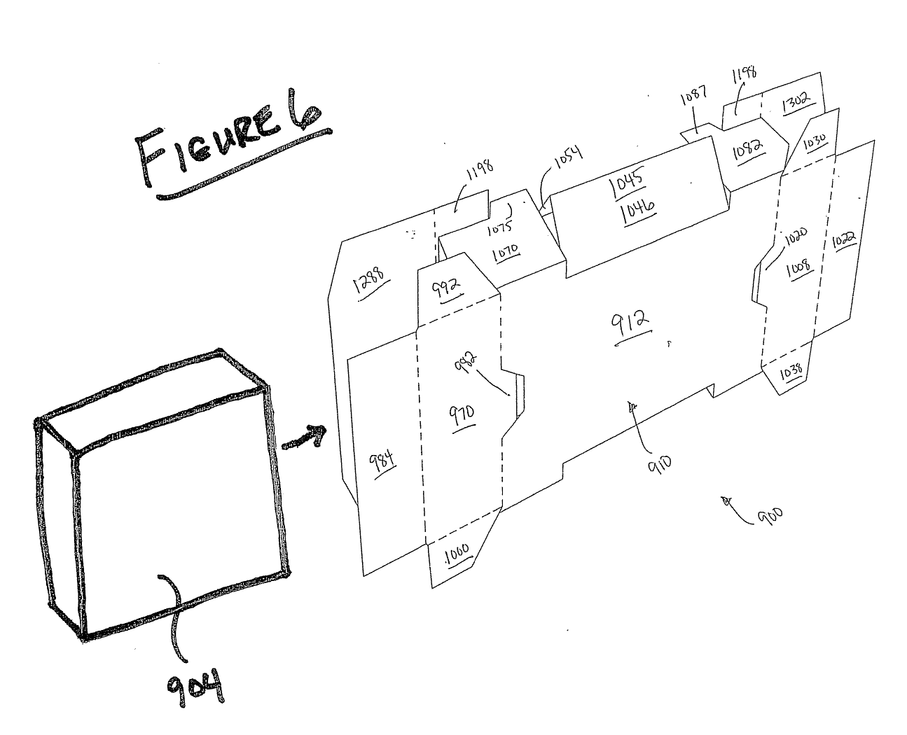

As illustrated in FIG. 7, if necessary, depending on the size and configuration of the product 904 wrapped and encapsulated within the blank 900, the second and fifth panel portions 1138, 1158, which form the V-panel 1165, can be pushed and folded inwardly along fold lines 942, 1140, 1160 toward the product 904 which is being wrapped and secured within the folded blank 900 such that the bottom surface 910 of the second and fifth panel portions 1138, 1158 generally face one another.

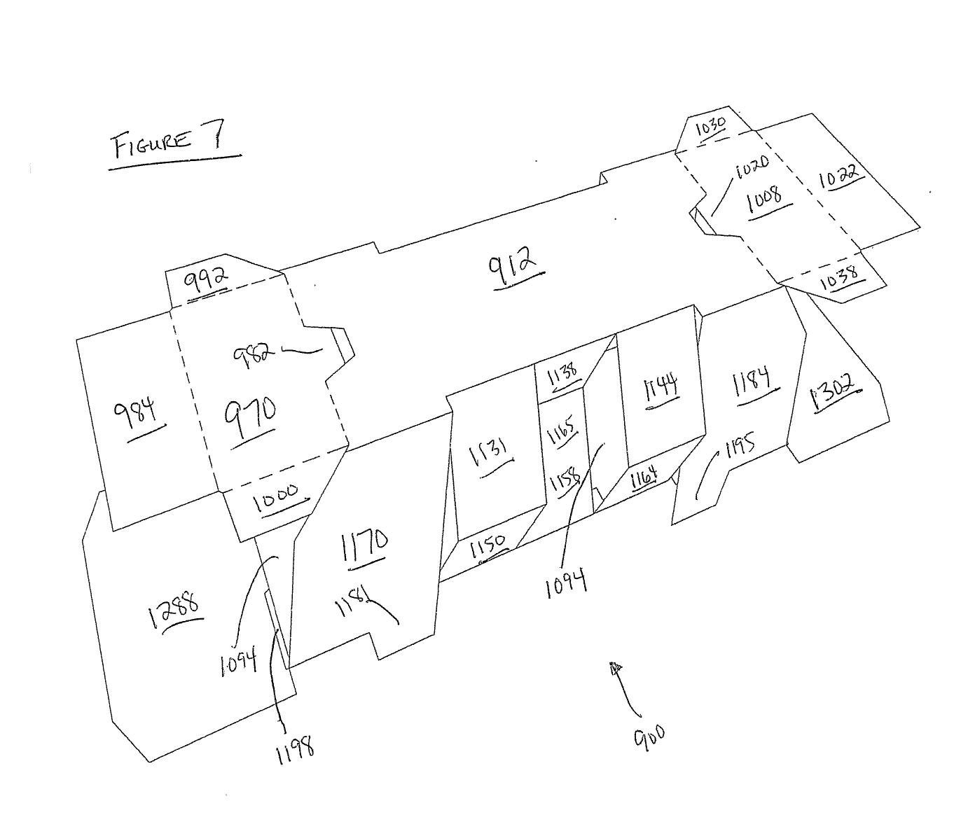

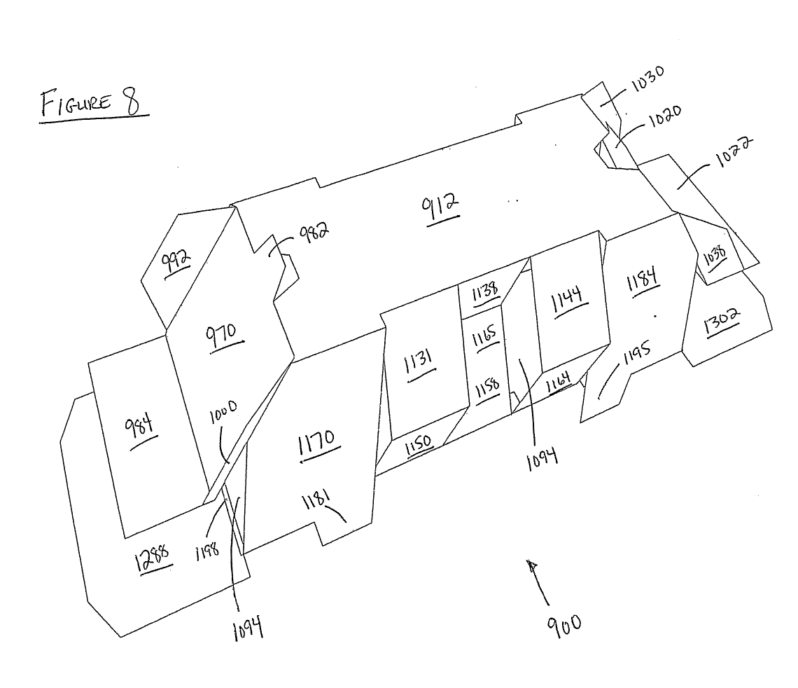

As illustrated in FIGS. 8 and 9, the folded blank 900 is preferably positioned against a working surface (not shown), such that the edges 1074, 1086, 1180, 1194 are positioned against the working surface and such that the bottom surface 908 of the second top panel 1198 and the third and fourth side panels 1288, 1302 generally face the working surface.

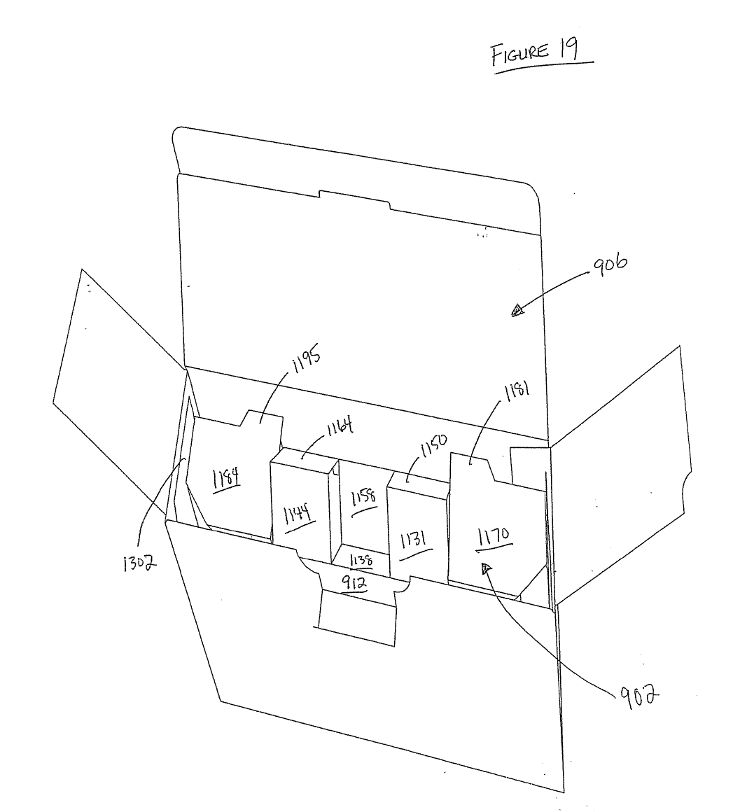

Depending on the size of the product 904 provided in the opening 903, each end of the blank 900 as illustrated in FIG. 8, can now be folded in three different methods. A first method A of closing off the ends of the opening 903 will be discussed with reference to FIGS. 8-11. A second method B of closing off the ends of the opening 903 will be discussed with reference to FIG. 20. A third method C of closing off the ends of the opening 903 will be discussed with reference to FIG. 21.

In method A, at one end of the opening 903, the first wing panel 992 is folded upwardly along fold line 972 until the first wing panel 992 is perpendicular to the first intermediate panel 970. Likewise, the second wing panel 1000 is folded upwardly along fold line 980 until the second wing panel 1000 is perpendicular to the first intermediate panel 970 and parallel to the first wing panel 992.

The bottom surface 908 of the first intermediate panel 970 is then pushed such that the first intermediate panel 970 folds downwardly relative to the base panel 912 along fold lines 922, 934 until the first intermediate panel 970 is perpendicular to both the base panel 912 and the first top panel 1094, as well as perpendicular to both the third and fifth intermediate panels 1070, 1170.

By folding the first intermediate panel 970 in this manner, the first side panel 984 is forced to fold relative to the first intermediate panel 970 along fold line 976 such that the first side panel 984 is perpendicular to the first intermediate panel 970, with the top surface 908 of the first side panel 984 facing and generally positioned against the top surface 908 of the first top panel 1094, but such that the edge 988 is positioned beyond the edge 1116 and over a portion of the top surface 908 of the third side panel 1288.

Also, by folding the first intermediate panel 970 in this manner, the first wing panel 992 is positioned against the third intermediate panel 1070 such that the top surface 908 of the first wing panel 992 faces, and generally abuts against, the top surface 908 of the third intermediate panel 1070. The edge 996 is thus positioned parallel to the edge 1080 and the first wing panel 992 is positioned generally perpendicular to the first intermediate panel 970 and the first side panel 984. Likewise, by folding the first intermediate panel 970 in this manner, the second wing panel 1000 is positioned against the fifth intermediate panel 1170 such that the top surface 908 of the second wing panel 1000 faces, and generally abuts against, the top surface 908 of the fifth intermediate panel 1170 and the second wing panel 1000 is positioned generally perpendicular to the first intermediate panel 970 and the first side panel 984, and is generally parallel to the first wing panel 992.

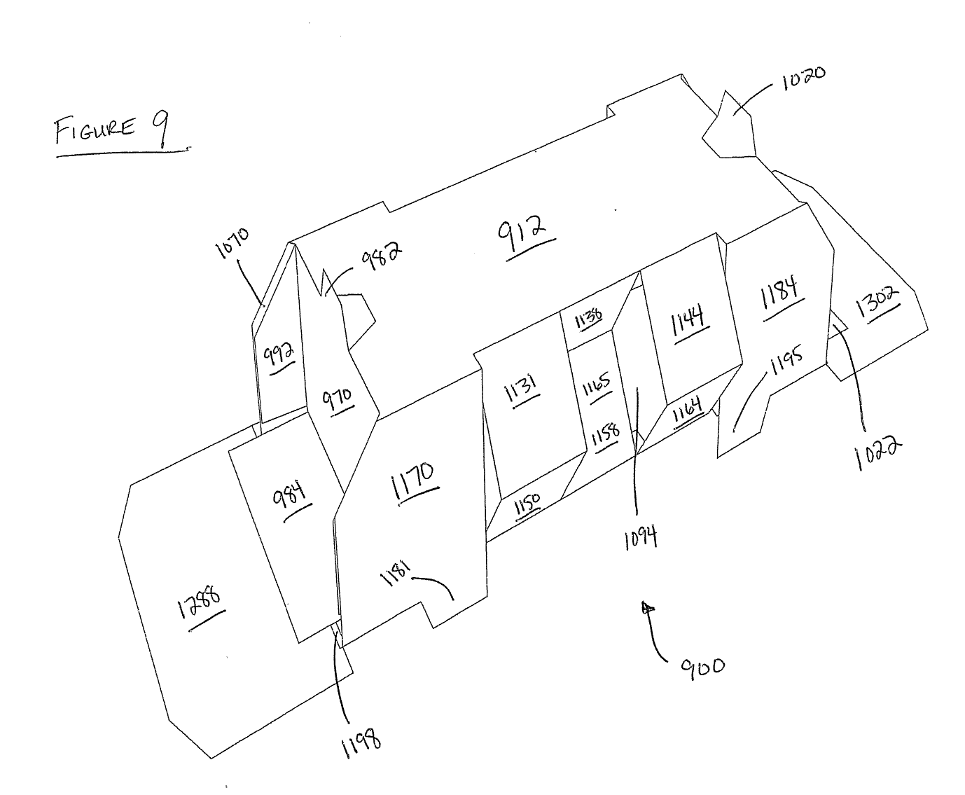

As illustrated in FIGS. 10 and 11, the first side panel 984 is folded upwardly relative to the first intermediate panel 970 along fold line 976 until the edge 988 generally meets the corner of the first wing panel 992 defined by the intersection of edge 996 and cut line 994, and the corner of the second wing panel 1000 defined by the intersection of edge 1004 and cut line 1002.

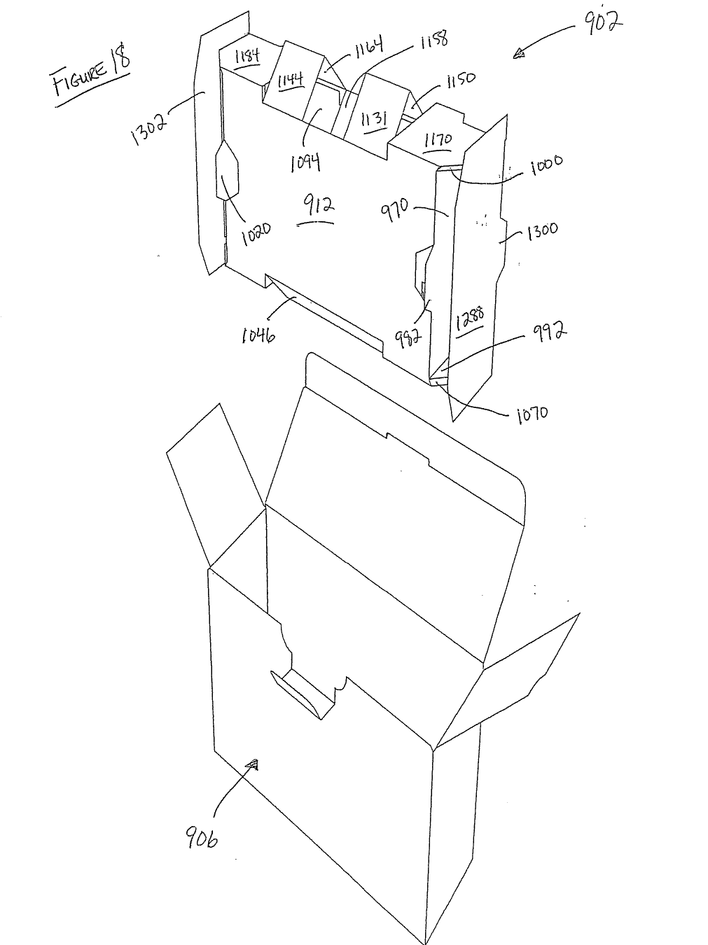

As illustrated in FIG. 11, the third side panel 1288 is then folded upwardly along fold lines 1200, 1212 such that the top surface 908 of the third side panel 1288 generally abuts against the edges 1080, 1172 of the third and fifth intermediate panels 1070, 1170, respectively, and against the edge 988 of the first side panel 984. Thus, the third side panel 1288 is positioned perpendicular to base panel 912, first and second top panels 1094, 1198, and third and fifth intermediate panels 1070, 1170. If desired, the first side panel 984 could be folded upwardly relative to the first intermediate panel 970 along fold line 976 by only folding the third side panel 1288 upwardly along fold lines 1200, 1212, as the third side panel 1288 would force the folding of the first side panel 984. Regardless, upon the third side panel 1288 being folded into its perpendicular position, the third side panel 1288 will prevent the first intermediate panel 970, the first side panel 984 and the first and second wing members 992, 1000 from moving outwardly (when the third side panel 1288 is held in this position, generally by the insert 902 being fit inside of a box 906 as illustrated in FIG. 19) such that the first intermediate panel 970 will abut against the product 904 positioned within the opening 903 in order to protect the product 904 from moving about within the opening 903, or at a minimum to be positioned proximate to the product 904 positioned within the opening 903 in order to minimize the amount of space provided between the end of the insert 902 and the product 904, thus minimizing the possibility of the product 904 moving around within the opening 903. The first and second wing panels 992, 1000 may be held in place by friction, but the folding of the third side panel 1288 keeps the first and second wing panels 992, 1000 in place as desired. The folding of the third side panel 1288 causes the first side panel 984 to find its own way, such that if no product 904 is provided within the opening 903, the first side panel 984 would fold inwardly, but if a product 904 is provided within the opening 903, the first side panel 984 generally will fold upwardly depending on the size of the product 904 within the opening 903.

Also in method A, at the other end of the opening 903, the third wing panel 1030 is folded upwardly along fold line 1010 until the third wing panel 1030 is perpendicular to the second intermediate panel 1008. Likewise, the fourth wing panel 1038 is folded upwardly along fold line 1018 until the fourth wing panel 1038 is perpendicular to the second intermediate panel 1008 and parallel to the third wing panel 1030.

The bottom surface 908 of the second intermediate panel 1008 is then pushed such that the second intermediate panel 1008 folds downwardly relative to the base panel 912 along fold lines 950, 962 until the second intermediate panel 1008 is perpendicular to both the base panel 912 and the first top panel 1094, as well as perpendicular to both the fourth and sixth intermediate panels 1082, 1184.

By folding the second intermediate panel 1008 in this manner, the second side panel 1022 is forced to fold relative to the second intermediate panel 1008 along fold line 1014 such that the second side panel 1022 is perpendicular to the second intermediate panel 1008, with the top surface 908 of the second side panel 1022 facing and generally positioned against the top surface 918 of the first top panel 1094, but such that the edge 1026 is positioned beyond the edge 1096 and over a portion of the top surface 908 of the fourth side panel 1302.

Also, by folding the second intermediate panel 1008 in this manner, the third wing panel 1030 is positioned against the fourth intermediate panel 1084 such that the top surface 908 of the third wing panel 1030 faces, and generally abuts against, the top surface 908 of the fifth intermediate panel 1082. The edge 1034 is thus positioned parallel to the edge 1092 and the third wing panel 1030 is positioned generally perpendicular to the second intermediate panel 1008 and the second side panel 1022. Likewise, by folding the second intermediate panel 1008 in this manner, the fourth wing panel 1038 is positioned against the sixth intermediate panel 1184 such that the top surface 908 of the fourth wing panel 1038 faces, and generally abuts against, the top surface 908 of the sixth intermediate panel 1184 and the fourth wing panel 1038 is positioned generally perpendicular to the second intermediate panel 1008 and the second side panel 1022, and is generally parallel to the third wing panel 1030.

As illustrated in FIGS. 10 and 11, the second side panel 1022 is folded upwardly relative to the second intermediate panel 1008 along fold line 1014 until the edge 1026 generally meets the corner of the third wing panel 1030 defined by the intersection of edge 1034 and cut line 1032, and the corner of the fourth wing panel 1038 defined by the intersection of edge 1042 and cut line 1040.

As illustrated in FIG. 11, the fourth side panel 1302 is then folded upwardly along fold lines 1240, 1252 such that the top surface 908 of the fourth side panel 1302 generally abuts against the edges 1092, 1186 of the fourth and sixth intermediate panels 1082, 1184, respectively, and against the edge 1026 of the second side panel 1022. Thus, the fourth side panel 1302 is positioned perpendicular to base panel 912, first and second top panels 1094, 1198, and fourth and sixth intermediate panels 1082, 1184. If desired, the second side panel 1022 could be folded upwardly relative to the second intermediate panel 1008 along fold line 1014 by only folding the fourth side panel 1302 upwardly along fold lines 1240, 1252, as the fourth side panel 1302 would force the folding of the second side panel 1022. Regardless, upon the fourth side panel 1302 being folded into its perpendicular position, the fourth side panel 1302 will prevent the second intermediate panel 1008, the second side panel 1022 and the third and fourth wing members 1030, 1038 from moving outwardly (when the fourth side panel 1302 is held in this position, generally by the insert 902 being fit inside of a box 906 as illustrated in FIG. 19) such that the second intermediate panel 1008 will abut against the product 904 positioned within the opening 903 in order to protect the product 904 from moving about within the opening 903, or at a minimum to be positioned proximate to the product 904 positioned within the opening 903 in order to minimize the amount of space provided between the end of the insert 902 and the product 904, thus minimizing the possibility of the product 904 moving around within the opening 903. The third and fourth wing panels 1030, 1038 may be held in place by friction, but the folding of the fourth side panel 1302 keeps the third and fourth wing panels 1030, 1038 in place as desired. The folding of the fourth side panel 1302 causes the second side panel 1022 to find its own way, such that if no product 904 is provided within the opening 903, the second side panel 1022 would fold inwardly, but if a product 904 is provided within the opening 903, the second side panel 984 generally will fold upwardly depending on the size of the product 904 within the opening 903.

In method B, as generally illustrated in FIG. 43, at one end of the opening 903, the first wing panel 992 is folded upwardly along fold line 972 until the first wing panel 992 is perpendicular to the first intermediate panel 970. Likewise, the second wing panel 1000 is folded upwardly along fold line 980 until the second wing panel 1000 is perpendicular to the first intermediate panel 970 and parallel to the first wing panel 992.

The bottom surface 908 of the first intermediate panel 970 is then pushed such that the first intermediate panel 970 folds downwardly relative to the base panel 912 along fold lines 922, 934 until the first intermediate panel 970 moves past perpendicular to both the base panel 912 and the first top panel 1094 (thus moving further into the opening 908 than in method A), such that the first intermediate panel 970 is provided at an acute angle relative to the base panel 912.

By folding the first intermediate panel 970 in this manner, the first side panel 984 is forced to fold relative to the first intermediate panel 970 along fold line 976 such that the top surface 908 of the first side panel 984 faces and is positioned generally flat against the top surface 908 of the top panel 1094, and such that the edge 988 is co-planar with the edge 1116 of the first top panel 1094.

Also, by folding the first intermediate panel 970 in this manner, the first wing panel 992 is positioned against the third intermediate panel 1070 such that the top surface 908 of the first wing panel 992 faces, and generally abuts against, the top surface 908 of the third intermediate panel 1070. A corner of the first wing panel 992 defined by the edges 996, 998 is thus generally positioned against the first top panel 1094. Likewise, by folding the first intermediate panel 970 in this manner, the second wing panel 1000 is positioned against the fifth intermediate panel 1170 such that the top surface 908 of the second wing panel 1100 faces, and generally abuts against, the top surface 908 of the fifth intermediate panel 1170. A corner of the second wing panel 1000 defined by the edges 1034, 1036 is thus generally positioned against the first top panel 1094.

Similar to the manner in which the third side panel 1288 is folded as illustrated in FIG. 1, the third side panel 1288 is then folded upwardly along fold lines 1200, 1212 such that the top surface 908 of the third side panel 1288 generally abuts against the edges 1080, 1172 of the third and fifth intermediate panels 1070, 1170, respectively, and against the edge 988 of the first side panel 984. Thus, the third side panel 1288 is positioned perpendicular to the base panel 912, first and second top panels 1094, 1198, third and fifth intermediate panels 1070, 1170, and the first side panel 984. Upon the third side panel 1288 being folded into its perpendicular position, the third side panel 1288 will prevent the first intermediate panel 970, the first side panel 984 and the first and second wing members 992, 1000 from moving outwardly (when the third side panel 1288 is held in this position, generally by the insert 902 being fit inside of a box 906) such that the first intermediate panel 970 will abut against the product 904 positioned within the opening 903 in order to protect the product 904 from moving about within the opening 903, or at a minimum to be positioned proximate to the product 904 positioned within the opening 903 in order to minimize the amount of space provided between the end of the insert 902 and the product 904, thus minimizing the possibility of the product 904 moving around within the opening 903.

Also in method B, as generally illustrated in FIG. 20, at one end of the opening 903, the third wing panel 1030 is folded upwardly along fold line 1010 until the third wing panel 1030 is perpendicular to the second intermediate panel 1008. Likewise, the fourth wing panel 1030 is folded upwardly along fold line 1018 until the fourth wing panel 1038 is perpendicular to the second intermediate panel 1008 and parallel to the third wing panel 1030.

The bottom surface 910 of the second intermediate panel 1008 is then pushed such that the second intermediate panel 1008 folds downwardly relative to the base panel 912 along fold lines 950, 962 until the second intermediate panel 1008 moves past perpendicular to both the base panel 912 and the first top panel 1094 (thus moving further into the opening 903 than in method A), such that the second intermediate panel 1008 is provided at an acute angle relative to the base panel 912.

By folding the second intermediate panel 1008 in this manner, the second side panel 1022 is forced to fold relative to the second intermediate panel 1008 along fold line 1014 such that the top surface 908 of the second side panel 1022 faces and is positioned generally flat against the top surface 908 of the first top panel 1094, and such that the edge 1026 is co-planar with the edge 1096 of the first top panel 1094.

Also, by folding the second intermediate panel 1008 in this manner, the third wing panel 1030 is positioned against the fourth intermediate panel 1082 such that the top surface 908 of the third wing panel 1030 faces, and generally abuts against, the top surface 908 of the fourth intermediate panel 1082. A corner of the third wing panel 1030 defined by the edges 1034, 1036 is thus generally positioned against the first top panel 1094. Likewise, by folding the second intermediate panel 1008 in this manner, the fourth wing panel 1038 is positioned against the sixth intermediate panel 1184 such that the top surface 908 of the fourth wing panel 1038 faces, and generally abuts against, the top surface 908 of the sixth intermediate panel 1184. A corner of the fourth wing panel 1038 defined by the edges 1042, 1044 is thus generally positioned against the first top panel 1094.

Similar to the manner in which the fourth side panel 1302 is folded as illustrated in FIG. 11, the fourth side panel 1302 is then folded upwardly along fold lines 1240, 1252 such that the top surface 908 of the fourth side panel 1302 generally abuts against the edges 1092, 1186 of the fourth and sixth intermediate panels 1082, 1184, respectively, and against the edge 1026 of the second side panel 1022. Thus, the fourth side panel 1302 is positioned perpendicular to the base panel 912, first and second top panels 1094, 1198, fourth and sixth intermediate panels 1082, 1184, and the second side panel 1022. Upon the fourth side panel 1302 being folded into its perpendicular position, the fourth side panel 1302 will prevent the second intermediate panel 1008, the second side panel 1022 and the third and fourth wing members 1030, 1038 from moving outwardly (when the fourth side panel 1302 is held in this position, generally by the insert 902 being fit inside of a box 906) such that the second intermediate panel 1008 will abut against the product 904 positioned within the opening 903 in order to protect the product 904 from moving about within the opening 903, or at a minimum to be positioned proximate to the product 904 positioned within the opening 903 in order to minimize the amount of space provided between the end of the insert 902 and the product 904, thus minimizing the possibility of the product 904 moving around within the opening 903.

In method B, the wing panels 992, 1000, 1030, 1038 generally do not provide any function, but the edges 998, 1006, 1036, 1044 of the wing panels 992, 1000, 1030, 1038 are angled as described such that the wing panels 992, 1000, 1030, 1038 can be folded further inwardly than as described in method A, because if the edges 998, 1006, 1036, 1044 were not angled as described, the edges 998, 1006, 1036, 1044 would interface with the first top panel 1094, such that the first and second intermediate panels 970, 1008 could not move as far into the opening 903 as is necessary.

In method C, as generally illustrated in FIG. 21, at one end of the opening 903, the first wing panel 992 is folded downwardly along fold line 972 until the first wing panel 992 is perpendicular to the first intermediate panel 970. Likewise, the second wing panel 1000 is folded downwardly along fold line 980 until the second wing panel 1000 is perpendicular to the first intermediate panel 970 and parallel to the first wing panel 992.

The bottom surface 908 of the first intermediate panel 970 is then pushed such that the first intermediate panel 970 folds downwardly relative to the base panel 912 along fold lines 922, 934 until the first intermediate panel 970 moves short of being perpendicular to both the base panel 912 and the first top panel 1094 (thus not moving as far into the opening 908 as in method A), such that the first intermediate panel 970 is provided at an obtuse angle relative to the base panel 912.

By folding the first intermediate panel 970 in this manner, the first side panel 984 is forced to fold relative to the first intermediate panel 970 along fold line 976 such that the top surface 908 of the first side panel 984 at the edge 988 is generally positioned against the top surface 908 of the top panel 1094, such that the fold line 976 is generally provided proximate to edge 1116 of the first top panel 1094.

Also, by folding the first intermediate panel 970 in this manner, the first wing panel 992 is positioned against the third intermediate panel 1070, within the opening 903, such that the bottom surface 910 of the first wing panel 992 faces, and generally abuts against, the top surface 908 of the third intermediate panel 1070. Likewise, by folding the first intermediate panel 970 in this manner, the second wing panel 1000 is positioned against the fifth intermediate panel 1170 such that the bottom surface 910 of the second wing panel 1100 faces, and generally abuts against, the top surface 908 of the fifth intermediate panel 1170.

Similar to the manner in which the third side panel 1288 is folded as illustrated in FIG. 11, the third side panel 1288 is then folded upwardly along fold lines 1200, 1212 such that the top surface 908 of the third side panel 1288 forces the first side panel 984 to fold upwardly along fold line 976 until the third side panel 1288 generally abuts against the edges 1080, 1172 of the third and fifth intermediate panels 1070, 1170, respectively. The third side panel 1288 will also abut against and be parallel to the first side panel 984 such that the top surface 908 of the first side panel 984 generally faces, and lies flush against, the top surface of the third side panel 1288. Thus, the third side panel 1288 is positioned perpendicular to the base panel 912, first and second top panels 1094, 1198, and the third and fifth intermediate panels 1070, 1170. Upon the third side panel 1288 being folded into its perpendicular position, the third side panel 1288 will prevent the first intermediate panel 970, the first side panel 984 and the first and second wing members 992, 1000 from moving outwardly (when the third side panel 1288 is held in this position, generally by the insert 902 being fit inside of a box 906) such that the first intermediate panel 970 will abut against the product 904 positioned within the opening 903 in order to protect the product 904 from moving about within the opening 903, or at a minimum to be positioned proximate to the product 904 positioned within the opening 903 in order to minimize the amount of space provided between the end of the insert 902 and the product 904, thus minimizing the possibility of the product 904 moving around within the opening 903.

Also, in method C, as generally illustrated in FIG. 21, at the other end of the opening 903, the third wing panel 1030 is folded downwardly along fold line 1010 until the third wing panel 1030 is perpendicular to the second intermediate panel 1008. Likewise, the fourth wing panel 1038 is folded downwardly along fold line 1018 until the fourth wing panel 1038 is perpendicular to the second intermediate panel 1008 and parallel to the third wing panel 1030.

The bottom surface 910 of the second intermediate panel 1008 is then pushed such that the second intermediate panel 1008 folds downwardly relative to the base panel 912 along fold lines 950, 962 until the second intermediate panel 1008 moves short of being perpendicular to both the base panel 912 and the first top panel 1094 (thus not moving as far into the opening 908 as in method A), such that the second intermediate panel 1008 is provided at an obtuse angle relative to the base panel 912.

By folding the second intermediate panel 1008 in this manner, the second side panel 1022 is forced to fold relative to the second intermediate panel 1008 along fold line 1014 such that the top surface 908 of the second side panel 1022 at the edge 1026 is generally positioned against the top surface 908 of the first top panel 1094, such that the fold line 1014 is generally provided proximate to edge 1096 of the first top panel 1094.

Also, by folding the second intermediate panel 1008 in this manner, the third wing panel 1030 is positioned against the fourth intermediate panel 1082, within the opening 903, such that the bottom surface 910 of the third wing panel 1030 faces, and generally abuts against, the top surface 908 of the fourth intermediate panel 1082. Likewise, by folding the second intermediate panel 1008 in this manner, the fourth wing panel 1038 is positioned against the sixth intermediate panel 1184 such that the bottom surface 910 of the fourth wing panel 1038 faces, and generally abuts against, the top surface 908 of the sixth intermediate panel 1184.

Similar to the manner in which the fourth side panel 1302 is folded as illustrated in FIG. 11, the fourth side panel 1302 is then folded upwardly along fold lines 1240, 1252 such that the top surface 908 of the fourth side panel 1302 forces the second side panel 1022 to fold upwardly along fold line 1014 until the fourth side panel 1302 generally abuts against the edges 1092, 1186 of the fourth and sixth intermediate panels 1082, 1184, respectively. The fourth side panel 1302 will also abut against and be parallel to the second side panel 1022 such that the top surface 908 of the second side panel 1022 generally faces, and lies flush against, the top surface 908 of the fourth side panel 1302. Thus, the fourth side panel 1302 is positioned perpendicular to the base panel 912, first and second top panels 1094, 1198, and the fourth and sixth intermediate panels 1082, 1184. Upon the fourth side panel 1302 being folded into its perpendicular position, the fourth side panel 1302 will prevent the second intermediate panel 1008, the second side panel 1022 and the third and fourth wing members 1030, 1038 from moving outwardly (when the fourth side panel 1302 is held in this position, generally by the insert 902 being fit inside of a box 906) such that the second intermediate panel 1008 will abut against the product 904 positioned within the opening 903 in order to protect the product 904 from moving about within the opening 903, or at a minimum to be positioned proximate to the product 904 positioned within the opening 903 in order to minimize the amount of space provided between the end of the insert 902 and the product 904, thus minimizing the possibility of the product 904 moving around within the opening 903.

In method C, the wing panels 992, 1000, 1030, 1038 and the first and second side panels 984, 1022 provide no real purpose, although the first and second side panels 984, 1022 can provide another layer of protection to the product 904 positioned within the opening 903.

In each of methods A, B and C, the upward folding of the third side panel 1288 along fold line 1200, 1212 causes the edge 1294 to extend beyond the bottom surface 910 of the base panel 912 such that the edge 1294 is generally co-planar with cut lines 981, 1019 of the tab portions 982, 1010 of the first and second intermediate panels 970, 1008, respectively. Also, the edge 1298 extends beyond the bottom surface 910 of the third intermediate panel 1070 such that the edge 1298 is generally co-planar with edge 1214 and fold line 1050. Further, the edge 1290 extends beyond the bottom surface 910 of the fifth intermediate panel 1170 such that the edge 1290 is generally co-planar with fold lines 1134, 1146.

Likewise, in each of methods A, B and C, the upward folding of the fourth side panel 1302 along fold lines 1240, 1252 causes the edge 1308 to extend beyond the bottom surface 910 of the base panel 912 such that the edge 1308 is generally co-planar with cut lines 981, 1019 of the tab portions 982, 1010 of the first and second intermediate panels 970, 1008, respectively. Also, the edge 1312 extends beyond the bottom surface 910 of the fourth intermediate panel 1082 such that the edge 1312 is generally co-planar with edge 1238 and fold line 1050. Further, the edge 1304 extends beyond the bottom surface 910 of the sixth intermediate panel 1184 such that the edge 1304 is generally co-planar with fold lines 1134, 1146.

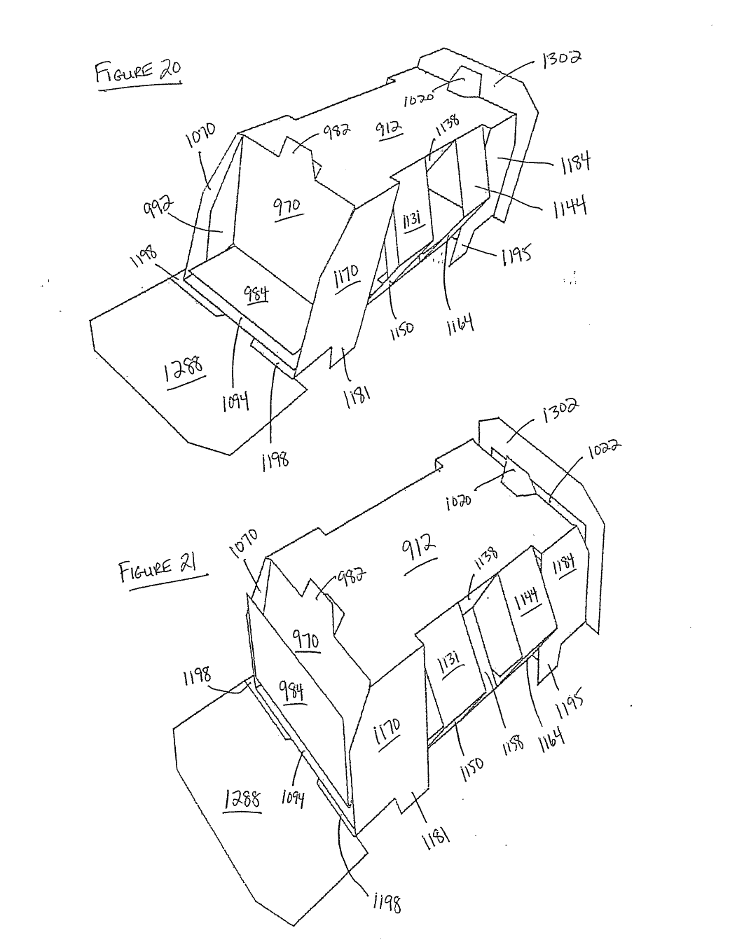

As illustrated in FIGS. 22-26, the ends of the opening 903 can be closed off in a number of different manners.

In FIG. 22, each end of the opening 903 is closed off using method A. In this instance, an interior length L1 of the opening 903 is defined between the top surface 908 of the first and second intermediate panels 970, 1008 proximate to fold lines 976, 1014, respectively. In the preferred embodiment of the blank 900 as described herein with regard to the specific dimensions, the interior length L1 is ten and one-eighth (10.125) inches.

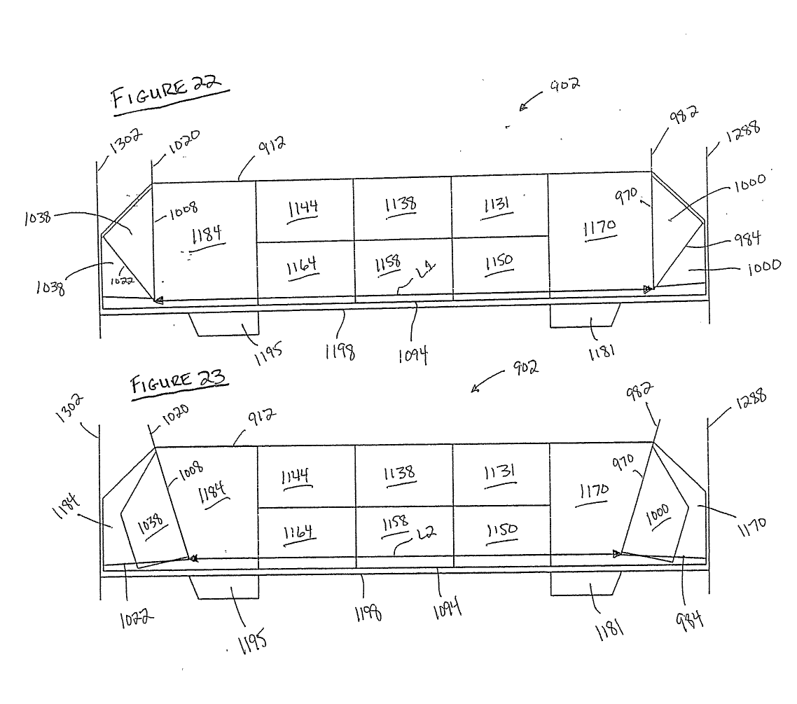

In FIG. 23, each end of the opening 903 is closed off using method B. In this instance, an interior length L2 of the opening 903 is defined between the top surface 908 of the first and second intermediate panels 970, 1008 proximate to fold lines 976, 1014, respectively. In the preferred embodiment of the blank 900 as described herein with regard to the specific dimensions, the interior length L2 is eight and one-half (8.5) inches.

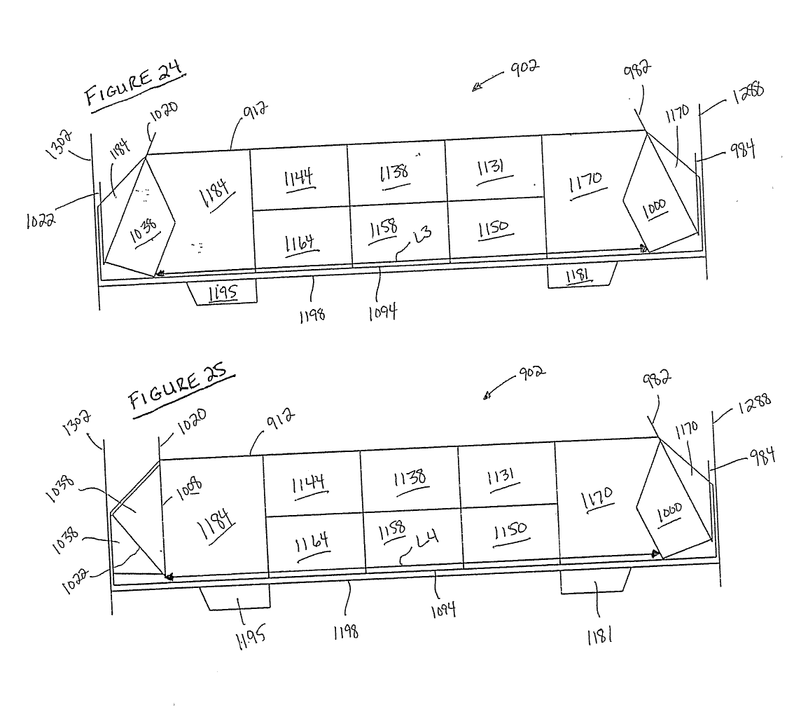

In FIG. 24, each end of the opening 903 is closed off using method C. In this instance, an interior length L3 of the opening 903 is defined between the top surface 908 of the first and second intermediate panels 970, 1008 proximate to fold lines 976, 1014, respectively. In the preferred embodiment of the blank 900 as described herein with regard to the specific dimensions, the interior length L3 is twelve (12) inches.

In FIG. 25, one end of the opening 903 is closed off using method A and the other end of the opening 903 is closed off using method C. In this instance, an interior length L4 of the opening 903 is defined between the top surface 908 of the first and second intermediate panels 970, 1008 proximate to fold lines 976, 1014, respectively. In the preferred embodiment of the blank 900 as described herein with regard to the specific dimensions, the interior length L4 is eleven (11) inches.

In FIG. 26, one end of the opening 903 is closed off using method A and the other end of the opening 903 is closed off using method B. In this instance, an interior length L5 of the opening 903 is defined between the top surface 908 of the first and second intermediate panels 970, 1008 proximate to fold lines 976, 1014, respectively. In the preferred embodiment of the blank 900 as described herein with regard to the specific dimensions, the interior length L5 is nine and one-quarter (9.25) inches.

Thus, interior length L3 is greater than interior length L4, which in turn, is greater than interior length L1, which in turn, is greater than interior length L5, which in turn, is greater than interior length L2.

In all cases of the preferred embodiment of the blank 900 as described herein with regard to the specific dimensions, the interior of the insert 902 has a width (between the base panel 912 and the first top panel 1094) of two and five-eighths (2.625) inches and a depth (between the third and fifth intermediate panels 1070, 1170 and between the fourth and sixth intermediate panels 1082, 1184) of four and three-fourth (4.75) inches. The depth, however, can be reduced to three and three-eighth (3.375) inches when the V-panel 1165 is pushed inwardly.

Thus, the insert 902 can be folded in a variety of ways in order to accommodate and better secure and protect the product 904 therein. If the product 904 has a depth which is greater than or equal to three and three-eighths (3.375) inches, the V-panel 1165 should not be pushed in, but if the depth of the product 904 is less than three and three-eighths (3.375) inches, the V-panel 1165 should be pushed in. If the product 904 has a length less than twelve (12) inches, but greater than or equal to eleven (11) inches, both ends of the opening 903 should be closed using method C. If the product 904 has a length less than eleven (11) inches, but greater than or equal to ten and one-eighth (10.125) inches, a combination of method A and method C should be used to close off the ends of the opening 903. If the product 904 has a length less than ten and one-eighth (10.125) inches, but greater than or equal to nine and one-quarter (9.25) inches, both ends of the opening 903 should be closed using method A. If the product 904 has a length less than nine and one-quarter (9.25) inches, but greater than or equal to eight and one-half (8.5) inches, a combination of method A and method B should be used to close off the ends of the opening 903. If the product 904 has a length less than eight and one-half (8.5) inches, both ends of the opening 903 should be closed using method B.

It should be noted that while a combination of methods B and C could be used to close off the ends of the opening 903, it is not desirable as it would provide for an interior length generally equal to the interior length L1, but in that instance the weight of the product 904 would not be generally centered within the opening 903 as it would be using a double method A, such that damage to the product 904 would thus be more likely.

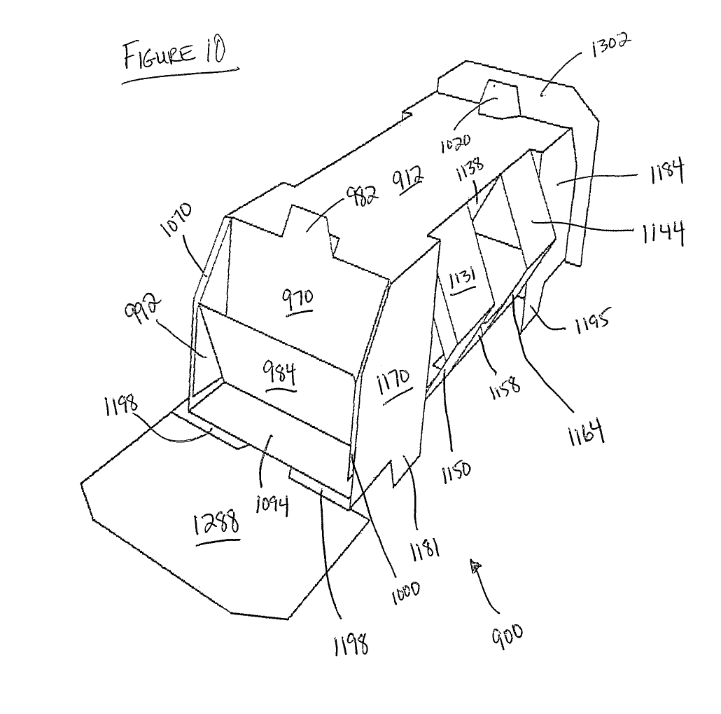

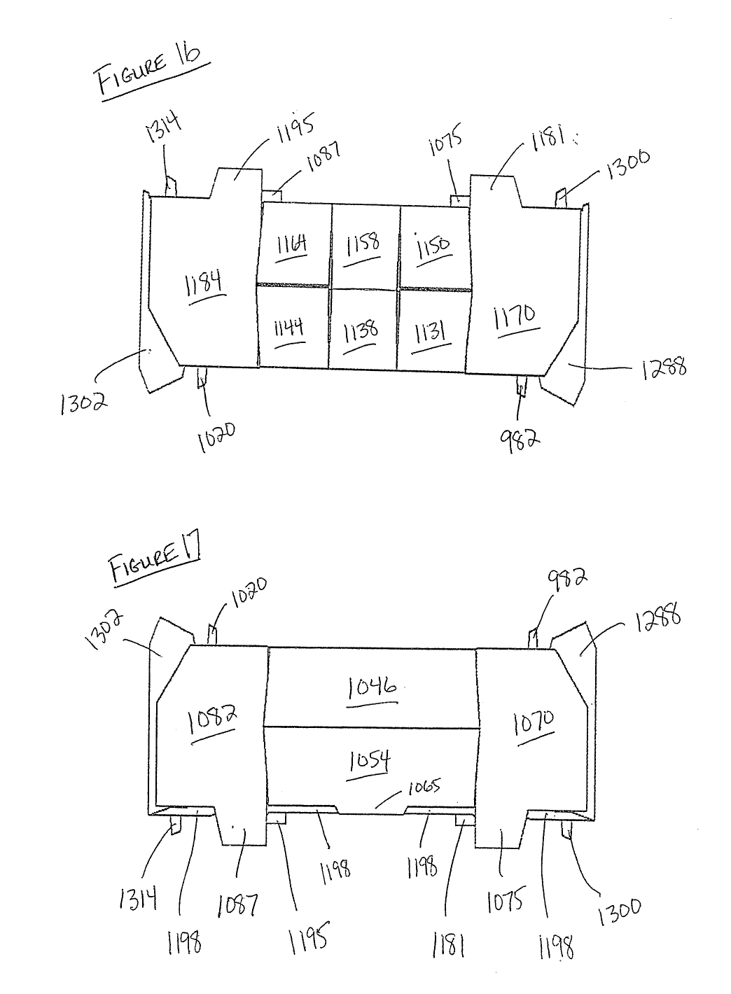

The insert 902 is thus formed with the product 904 protected and secured therein. The insert 902, formed by using method A to close off both ends of the opening 903, is best illustrated in FIGS. 12-17. The insert 902 is then inserted into the box or shipping container 906, as illustrated in FIG. 18, which is appropriately sized and configured to receive and secure the insert 902 therein, such that the bottom surface 910 of the third and fourth side panels 1288, 1302 face opposite side walls of the box 906.

When positioned within the box 906, the configuration of the insert 902 provides a number of air cells to further protect the product 904 within the insert 902. The tab portions 982, 1020 and the edges 1294, 1308 of the third and fourth side panels 1288, 1302, respectively, create an air cell between the insert 902 and a side of the box 906. Likewise, the tab portions 1075, 1087, 1181, 1195 create an air cell between the insert 902 and a side of the box 906. The bridge panel 1045, the edges 1214, 1238 of the second top panel 1198, and the edges 1298, 1312 of the third and fourth side panels 1288, 1302, respectively, create an air cell between the insert 902 and either a top or bottom of the box 906. The bridge panel 1130 and the edges 1290, 1304 of the third and fourth side panels 1288, 1302, respectively, create an air cell between the insert 902 and either the top or bottom of the box 906. The closing off of the ends of the opening 903 by methods A, B and/or C, in combination with the folding of the third and fourth side panels 1288, 1302 further protect the product 904.

The bridge panels 1045, 1130 thus generally provide stable top and bottom air cells. The bridge panels 1045, 1130 also provide the insert 902 with a generally hexagonal or 6-sided cross-section such that the insert 902 has relief or void areas that the product 904 secured within the insert 902 cannot or do not reach, thus creating natural air cells within the insert 902.

The V-panel 1165 of the bridge panel 1130 can be popped/folded down to decrease the interior dimension of the insert 902 when necessary depending on the size and configuration of the product 904 positioned within the insert 902, in order to allow multiple types of products 904 of significantly different sizes to be secured in place with minimal movement. The insert 902 is configured to be centered within the box 906, and the product 904 is generally centered within the insert 902.

The dimensions of the blanks 100, 500, 900 can be changed as desired such that the inserts 102, 502, 902 formed therefrom can fit into different sized and shaped boxes 106, 506, 906, and such that the inserts 102, 502, 902 can accommodate and secure and protect different sized and shaped products 104, 504, 904.

The layers of corrugated fibreboard also provide cushioning to provide further protection to the products 104, 504, 904 secured within the inserts 102, 502, 902.

The inserts 102, 502, 902 are also environmentally friendly as it is formed of corrugated fibreboard which is easily and readily recyclable. By forming the inserts 102, 502, 902 of corrugated fibreboard, the inserts 102, 502, 902 are also inexpensive to manufacture and, thus, is very cost effective.

Further, the inserts 102, 502, 902 are space-saving as they are formed from the blanks 100, 500, 900 which both ship and store flat.

It should further be noted that, if desired, the blank 900 could be reconfigured such that the insert 902 would be formed by the use of an adhesive rather than with the locking tab member 1266.

While a preferred embodiment of the invention is shown and described, it is envisioned that those skilled in the art may devise various modifications without departing from the spirit and scope of the foregoing description.

The invention is claimed as follows:

1. An insert for receiving and protecting at least one of a plurality of different sized and shaped products, said insert comprising:
a member having an opening extending therethrough for receiving and protecting the product therein;
first means for closing off a first end of said opening; and
second means for closing off a second end of said opening, at least one of said first and second closing means configured to be closed in varying manners such that an interior length of said opening can be varied depending on the size and shape of the products.

2. An insert as defined in claim 1, wherein said first closing means comprises a first set of panels configured to close off said first end of said opening, and wherein said second closing means comprises a second set of panels configured to close off said second end of said opening.

3. An insert as defined in claim 2, wherein each set of panels comprises an intermediate panel joined to said member, a side panel joined to said intermediate panel opposite to where said intermediate panel is joined to said member, and first and second wing panels joined to opposite sides of said intermediate panel.

4. An insert as defined in claim 1, further comprising panel means for holding said first and second closing means in position.

5. An insert as defined in claim 1, wherein said member has at least one bridge panel formed therein for creating an air cell between said insert and the product positioned within said opening.

6. An insert as defined in claim 5, wherein said member has two bridge panels formed therein for creating two air cells between said insert and the product positioned within said opening, said bridge panels being positioned generally opposite one another.

7. An insert as defined in claim 6, wherein said member has a cross-section which is generally hexagonal when taken about said two bridge panels, but which is generally quadrilateral when not taken about said two bridge panels.

8. An insert as defined in claim 5, wherein said at least one bridge panel includes a portion thereof which is configured to be folded into said opening in order to decrease an interior dimension of said member such that the product may be secured within said opening of said member with minimal movement.

9. An insert as defined in claim 1, wherein said member includes a portion thereof which is configured to be folded into said opening in order to decrease an interior dimension of said member such that the product may be secured within said opening of said member with minimal movement.

10. An insert as defined in claim 1, further comprising at least one tab member extending outwardly from said member, said at least one tab member configured to space a remainder of said member from a sidewall of a box when said insert is packed inside the box.

11. An insert as defined in claim 1, wherein said member is formed by folding a single corrugated fibreboard blank and by inserting a locking tab of said corrugated fibreboard blank into an aperture formed during the folding of said corrugated fibreboard blank.

12. An insert for receiving and protecting at least one of a plurality of different sized and shaped products, said insert comprising:
a member having at least a first portion which is generally quadrilateral in cross-section and at least a second portion which is generally hexagonal in cross-section, said member defining an opening therethrough for receiving and protecting the product therein; and
means for closing off opposite ends of said opening.

13. An insert as defined in claim 12, wherein said second portion of said member is provided between first portions of said member.

14. An insert as defined in claim 12, wherein said member includes two bridge panels for creating two air cells between said insert and the product positioned within said opening, said bridge panels being positioned generally opposite one another, said second portion of said member being taken about said two bridge panels.

15. An insert as defined in claim 14, wherein at least one of said two bridge panels has a portion thereof which is configured to be folded into said opening in order to decrease an interior dimension of said member such that the product may be secured within said opening of said member with minimal movement.

16. An insert as defined in claim 12, wherein said member has at least one portion thereof which is configured to be folded into said opening in order to decrease an interior dimension of said member such that the product may be secured within said opening of said member with minimal movement.

17. An insert as defined in claim 12, further comprising at least one tab member extending outwardly from said member, said at least one tab member configured to space a remainder of said member from a sidewall of a box when said insert is packed inside the box.

18. An insert as defined in claim 12, wherein said member is formed by folding a single corrugated fibreboard blank and by inserting a locking tab of the corrugated fibreboard blank into an aperture formed during the folding of the corrugated fibreboard blank.

19. An insert as defined in claim 12, further comprising panels which are connected to said member, said panels configured to be positioned between said closing means and a sidewall of a box when said insert is packed inside the box, such that further protection is provided between the box and the product secured within said opening.

20. An insert as defined in claim 12, wherein said insert is formed from a single corrugated fibreboard blank.

21. An insert as defined in claim 12, wherein said closing means is configured to be closed in varying manners such that an interior length of said opening can be varied depending on the size and shape of the products.

22. An insert as defined in claim 21, wherein said closing means comprises a first set of panels configured to close off a first end of said opening and a second set of panels configured to close off a second end of said opening.

23. An insert as defined in claim 22, wherein each set of panels comprises an intermediate panel joined to said member, a side panel joined to said intermediate panel opposite to where said intermediate panel is joined to said member, and first and second wing panels joined to opposite sides of said intermediate panel.

24. An insert as defined in claim 21, further comprising panel means for holding said closing means in position.

25. An insert for receiving and protecting at least one of a plurality of different sized and shaped products, said insert being formed from a single corrugated fibreboard blank, said insert comprising:
a plurality of panels configured to define an opening in which the product is encapsulated within, said plurality of panels further being configured to be folded in a plurality of manners in order to vary an interior length of said opening depending on a size and shape of the product.

26. An insert as defined in claim 25, wherein said plurality of panels are configured to be folded such that said opening can be varied to provide at least five distinct interior lengths of said opening.

27. A blank configured to be folded into an insert for protecting a product, said blank comprising:
a base panel generally having first, second, third and fourth sides, said first and second sides being positioned opposite one another, said third and fourth sides being positioned opposite one another, said first and second side being positioned generally perpendicular to said third and fourth sides;
first, second, third, fourth, fifth and sixth intermediate panels, said first intermediate panel being joined to said first side of said base panel, said second intermediate panel being joined to said second side of said base panel, said third and fifth intermediate panels being joined to said third side of said base panel, said fourth and sixth intermediate panels being joined to said fourth side of said base panel, said third and fourth intermediate panels being positioned opposite one another, and said fifth and sixth intermediate panels being positioned opposite one another;
first and second bridge panels, said first bridge panel being joined to said third side of said base panel and being positioned between said third and fifth intermediate panels, said second bridge panel being joined to said fourth side of said base panel and being positioned between said fourth and sixth intermediate panels;
first and second top panels, said first top panel being joined to said third and fifth intermediate panels and said first bridge panel opposite of where said third and fifth intermediate panels and said first bridge panel are joined to said base panel, said second top panel being joined to said fourth and sixth intermediate panels and said second bridge panel opposite of where said fourth and sixth intermediate panels and said second bridge panel are joined to said base panel;
first, second, third and fourth side panels, said first side panel being joined to said first intermediate panel along a side of said first intermediate panel which is opposite said first side of said base panel, said second side panel being joined to said second intermediate panel along a side of said second intermediate panel which is opposite said second side of said base panel, said third and fourth side panels being joined to opposite sides of said second top panel, said opposite sides of said second top panel being generally perpendicular to a side of said second top panel which is joined to said fourth and sixth intermediate panels and said second bridge panel; and
first, second, third and fourth wing panels, said first and second wing panels being joined to opposite sides of said first intermediate panel, said opposite sides of said first intermediate panel being generally perpendicular to said sides of said first intermediate panel which are joined to said first side of said base panel and said first side panel, said third and fourth wing panels being joined to opposite sides of said second intermediate panel, said opposite sides of said second intermediate panel being generally perpendicular to said sides of said second intermediate panel which are joined to said second side of said base panel and said second side panel.

28. A blank as defined in claim 27, wherein said second bridge panel defines a fold line which generally extends from said fourth intermediate panel to said sixth intermediate panel, and wherein said second bridge panels includes a V-panel which includes first and second portions which are secured to one another along a portion of said fold line.

29. A blank as defined in claim 27, wherein said base panel, said third, fourth, fifth and sixth intermediate panels, said first and second bridge panels, and said first and second top panels are configured to be folded to form a member having first and second ends and having, in series from said first end to said second end, a generally quadrilateral cross-section, a generally hexagonal cross-section, and a generally quadrilateral cross-section, said member having an opening provided therethrough from said first end to said second end.

30. A blank as defined in claim 29, wherein said first and second intermediate panels, said first and second side panels, and said first, second, third and fourth wing panels are configured to be folded to generally close off said opening at said first and second ends.

31. A blank as defined in claim 30, wherein said first and second intermediate panels, said first and second side panels, and said first, second, third and fourth wing panels are configured to be folded in a plurality of manners in order to vary an interior length of said opening depending on a size and shape of the product.

32. A blank as defined in claim 31, wherein said first and second intermediate panels, said first and second side panels, and said first, second, third and fourth wing panels are configured to be folded such that said opening can be varied to provide at least five distinct interior lengths of said opening.

33. A blank as defined in claim 30, wherein said third side panel is configured to be folded such that said third side panel is positioned between said first intermediate and side panels and a sidewall of a box when the insert is packed inside the box, and wherein said fourth side panel is configured to be folded such that said forth side panel is positioned between said second intermediate and side panels and an opposite sidewall of the box when the insert is packed inside the box.

34. A blank as defined in claim 29, wherein said first and second top panels are secured to one another by a tab member provided on said second top panel being locked into an aperture formed during the folding of said blank.

35. A blank as defined in claim 27, wherein said blank is formed of corrugated fibreboard.

36. A method of folding a blank to form an insert configured to receive and protect a product, said method comprising the steps of:
folding a first set of panels of said blank to form a member having an opening extending therethrough; and
folding a second set of panels of said blank in order to close off ends of said opening in one of a plurality of manners which define varying interior lengths of said opening depending on a size and shape of the product.

37. A method as defined in claim 36, further comprising the step of:
folding a third set of panels of said blank such that said third set of panels is positioned between said second set of panels and a sidewall of a box when said insert is packed inside a box.

38. A method as defined in claim 36, wherein said member is generally formed to have at least a portion thereof which is quadrilateral in cross-section and at least a portion thereof which is hexagonal in cross-section.

39. A method as defined in claim 38, wherein said member is generally formed to have, in series, a generally quadrilateral portion in cross-section, a generally hexagonal portion in cross-section, and a generally quadrilateral portion in cross-section.

40. A method as defined in claim 36, further comprising the step of:
folding at least one portion of said first set of panels into said opening in order to decrease an interior dimension of said member.

41. A method as defined in claim 36, further comprising the step of:
securing said first set of panels in said form of said member by inserting a locking tab of said blank into an aperture formed during the folding of said blank.
